(19) United States
(12) Patent Application Publication
(10) Pub. No.: US 2026/0099902 A1
(43) Pub. Date: Apr. 9, 2026

(54) NEURAL LOCAL ATTENTION MODULES FOR DENOISING DEEP MONTE CARLO RENDERINGS

(71) Applicants: Disney Enterprises, Inc., Burbank, CA (US); ETH Zürich (Eidgenössische Technische Hochschule Zürich), Zürich (CH)

(72) Inventors: Marios PAPAS, Zürich (CH); Gerhard RÖTHLIN, Zürich (CH); Tunç Ozan AYDIN, Zürich (CH); Xianyao ZHANG, Zürich (CH); Farnood SALEHI, Zürich (CH); Shilin ZHU, Burbank, CA (US)

(73) Assignees: Disney Enterprises, Inc., Burbank, CA (US); ETH Zürich (Eidgenössische Technische Hochschule Zürich), Zürich (CH)

(21) Appl. No.: 18/906,951

(22) Filed: Oct. 4, 2024

(51) Int. Cl. G06T 5/70; G06T 5/40; G06T 5/60

(52) U.S. Cl. CPC G06T 5/70; G06T 5/40; G06T 5/60; G06T 2207/20081

(57) ABSTRACT

Methods, systems, and machine learning models for denoising deep images are disclosed. Deep image renders can be generated using Monte Carlo rendering methods such as path tracing. Unfortunately, such renders may have visual noise. A machine learning model according to embodiments can be trained to denoise deep images, and can comprise an embedding sub-model and a denoising sub-model. A computer system can use the embedding sub-model to generate a deep image embedding based on a noisy deep image input using novel local attention mechanisms. The computer system can use the denoising sub-model to denoise the noisy deep image using the deep image embedding. In some embodiments, the computer system can use the denoising sub-model to generate denoised deep images at multiple levels (or “scales”) and combine the denoised deep images to produce an output denoised deep image.

### BACKGROUND

“Rendering” can refer to the process of generating an image from a two dimensional or three dimensional model by means of a computer program. Rendering is often performed in the entertainment industry (e.g., television, film, and videogame production). As an example, for a science fiction or fantasy film, a team of graphic artists may design a 3D model of the landscape of an exotic planet. This landscape may be rendered and footage of an actor (e.g., acting in front of a green screen) may be superimposed on the rendered image, creating the appearance that the actor is on the exotic planet. Some animated films are made entirely or almost entirely of sequences of rendered images, sometimes referred to as “frames”.

In the field of computer graphics, there are various types of images. In raster graphics, two dimensional images are represented as a rectangular matrix or grid of “pixels.” In a flat raster image, each pixel may be associated with one or more color channels (e.g., red, green, and blue color channels), which may collectively define the color of the pixel. When viewed as a whole, the entire grid of pixels resembles the subject of the image. Many digital images on computers and the Internet comprise flat raster images.

However, there are other types of images, including the “deep images”. A deep image can also be represented by a rectangular matrix or grid. However, unlike a flat image, in which each grid cell is associated with a single pixel, each grid cell in a deep image can be associated with zero or more “bins.” Generally, these bins can contain information that would be associated with a pixel in a flat image, e.g., red, green, and blue color channel information, etc. When the deep image is displayed, the contents of each bin can collectively define the appearance of their respective pixels. Deep images can be easier for graphical artists to work with, as they can enable artists to manipulate bins associated with particular objects without affecting other objects within the scene and provide artists with more freedom during compositing.

There are various techniques that can be used to render images, including deep images. Some of these techniques work by modeling light transportation, e.g., by modelling the emission of light from light sources as it is reflected off the surfaces of objects and into a virtual “camera”, representing the point of view of the rendered image. “Path tracing” is a computer graphics Monte Carlo method for rendering images that can realistically model the illuminance on modeled 3D objects, and can be used to produce photorealistic images when used with physically accurate surface models.

While path tracing and other Monte Carlo methods can be used for producing high quality images, doing so often takes a considerable amount of computing time and computing resources. While performing path tracing, a computer can continuously sample pixels (or bins) in an image, and while it may only take a few hundred samples to produce a recognizable render of a three dimensional scene, such renders often have random speckling noise that looks like “film grain” or television static. To produce images that are free of noise, many thousand (e.g., 5,000 or more) samples may be needed. As a result, Monte Carlo rendering methods are very time intensive and require large amounts of computing resources. Monte Carlo rendering can be very costly when large numbers of high resolution images need to be rendered, e.g., in an animated feature film.

One solution to this problem is the use of denoising. Rather than generating a high quality (e.g., noiseless, or nearly noiseless) rendering, a lower quality noisy rendering can be generated and then denoised. Because denoising often takes significantly less time than rendering, rendering and denoising can often produce high quality renderings more quickly and efficiently than rendering alone. Various techniques for denoising, including those using convolutional neural networks (e.g., Zhang et al. 2024 [18]) have been used to successfully denoise rendered images.

However, the structure and characteristics of deep images make them considerably more difficult to denoise than flat images. Because each grid cell in a deep image can be associated with a different number of bins, it is difficult to process deep images using convolutional neural networks (or other similar machine learning models) which require regularly structured input data. As such, considerable pre-processing is needed to denoise deep images using convolutional neural networks, and in some cases it may not be possible, e.g., if depth information used to pre-process the deep image is unavailable. Often, the quality of denoised deep images is lower than what is needed or desired for film and television programs. This is unfortunate, as many digital artists or other professional prefer working with deep images over flat images, as it is often easier to composite, recomposite, or otherwise edit scenes depicted by deep images.

Embodiments address these and other problems, individually and collectively.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

Embodiments of the present disclosure are directed to methods, machine learning models, and computer systems (which may perform said methods and instantiate, train and run said machine learning models), for denoise deep images using novel local attention mechanisms. Machine learning models can be trained to take a noisy deep image as an input and produce a denoised deep image as an output. Such deep images could be generated using Monte Carlo rendering techniques such as path tracing or another other rendering technique.

A machine learning model according to embodiments can comprise an embedding sub-models (sometimes referred to as a “core network”) and a denoising sub-model (sometimes referred to as “one or more reconstruction blocks”). An embedding sub-model can take a noisy deep image as an input and produce a deep image embedding. The denoising sub-model can use the deep image embedding to denoise the noisy deep image, thereby producing a denoised deep image.

Several model architectures and denoising methods are described in more detail further below. Generally however, these methods and machine learning models use a novel local attention mechanism for the purpose of generating the deep image embedding and denoising the deep image. In general terms, conventional attention mechanisms are poorly suited to processing (e.g., denoise) images, due to quadratic time and memory scaling with respect to inputs (i.e., number of pixels or bins). As a result, attention is typically not used to denoise deep images, and no prior work has used local region-based attention to denoise deep images. However, novel local attention mechanisms according to embodiments enable highly efficient deep image denoising, and methods according to embodiments often outperform state of the art denoising methods in terms of the quality of denoised images.

In more detail, one embodiment is directed to a method performed by a computer system for denoising a deep image comprising a plurality of pixels. Each pixel can correspond to one or more bins (In some cases, the deep image may comprise other pixels, in addition to the plurality of pixels, and the additional pixels may correspond to zero bins), and the deep image can thereby comprise a plurality of bins. The computer system can generate a deep image embedding using an embedding sub-model. The computer system can do so by determining a plurality of local bin sets corresponding to the plurality of bins. Each local bin set can comprise a plurality of local bins from the plurality of bins and a respective focal bin. Each plurality of local bins can be within a specified distance of the respective focal bin. The computer system can generate a bin embedding for each focal bin using the embedding sub-model. The bin embedding can be based on attention of a corresponding local bin set. In this way, the computer system can generate a plurality of bin embeddings. The computer system can then generate the deep image embedding based on the plurality of bin embeddings. The computer system can then generate a denoised deep image by generating a plurality of denoised bins using a denoising sub-model by applying the denoising sub-model to the plurality of bins of the deep image and the deep image embedding. The denoised deep image can comprise the plurality of denoised bins.

Another embodiment is directed to a method performed by a computer system for training a machine learning model to denoise deep images comprising pluralities of pixels. Each pixel can correspond to one or bins, and each deep image can thereby comprise a plurality of bins. The machine learning model can comprise an embedding sub-model and a denoising sub-model. The computer system can perform an iterative training process until a terminating condition has been met. In the iterative training process, the computer system can sample a batch of training deep images comprising one or more training deep images. Each training deep image can comprise a plurality of training bins. Using the embedding sub-model, the computer system can generate one or more training deep image embeddings by performing a series of steps for each deep image of the one or more training deep images. The computer system can determine a plurality of local bin sets corresponding to the plurality of training bins. Each local bin set can comprise a plurality of local bins from the plurality of training bins and a respective focal training bin. Each plurality of local bins can be within a specified distance of the respective focal training bin. For each focal training bin, the computer system can use the embedding sub-model to generate a training bin embedding based on attention of a corresponding local bin set, thereby generating a plurality of training bin embeddings. The computer system can generate one or more denoised training deep images by generating a denoised training deep image for each training deep image. The computer system can do so by generating a plurality of denoised training bins using a denoising sub-model applied to a plurality of training bins of a corresponding training deep image and a corresponding training deep image embedding, thereby generating the one or more training deep images. The computer system can determine one or more loss values based on the one or more denoised deep images. The computer system can update a parameter set of the machine learning model based on the one or more loss values, thereby training the machine learning model. If the terminating condition has not been met, the computer system can repeat the iterative training process until the terminating condition has been met. Otherwise the computer system can complete the training process.

Another embodiment is directed to a computer system comprising one or more processors and a non-transitory computer readable medium coupled to the one or more processors. The non-transitory computer readable medium can comprise code or instructions, executable by the one or more processors for performing either of the above methods (or any other methods described herein).

### TERMS

A “server computer” may include a powerful computer or cluster of computers. For example, a server computer can include a large mainframe, a minicomputer cluster, or a group of servers functioning as a unit. In one example, a server computer can include a database server coupled to a web server. The server computer may comprise one or more computational apparatuses and may use any of a variety of computing structures, arrangements, and compilations for servicing the requests for one or more client computers.

A “memory” may include any suitable device or devices that may store electronic data. A suitable memory may comprise a non-transitory computer readable medium that stores instructions that can be executed by a processor to implement a desired method. Examples of memories include one or more memory chips, disk drives, etc. Such memories may operate using any suitable electrical, optical, and/or magnetic mode of operation. A “memory buffer” can include a region of memory used to temporarily store data.

A “processor” may include any suitable data computation device or devices. A processor may comprise one or more microprocessors working together to accomplish a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or XScale; and/or the like processor(s).

A “data set” may include any set of one or more “observations” or “data values.” A “data value” can include any data element. A data value can comprise a “data vector,” one or more values (represented in vector form) corresponding to a data element or observation. A “data sequence” may comprise a data set in which the data values or observations are ordered in a sequence.

“Sampling” may include any process or method used to collect data values. Sampling can be used to collect data values from an existing data set. The act of sampling may result in a “sample,” one or more data values collected from the data set during sampling. Data sets can be sampled via a variety of means. For example, “random sampling” involves sampling data values from a data set randomly. A “window” or “window of data” may include any number of contiguous data elements from a data set. A “window” may be defined by a starting data value and an ending data value, such that the window contains all data values between the starting data value and ending data value (and optionally the starting data value and ending data values themselves). “Window sampling” can be used to sample data values contained within a window of data.

A “machine learning model” (ML model) can refer to a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, 500,000, 1,000,000, 5,000,000, 10,000,000, 50,000,000 or 100,000,000 parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model. Another example type of model is supervised learning that can be used with embodiments of the present disclosure. Example supervised learning models may include different approaches and algorithms including analytical learning, statistical models, artificial neural network (e.g. including convolutional and/or transformer layers), boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ordinal classification, data pre-processing, handling imbalanced datasets, statistical relational learning, or Proaftn (a multicriteria classification algorithm), or an ensemble of any of these types. The model may include linear regression, logistic regression, deep recurrent neural network (e.g., long short term memory, LSTM), hidden Markov model (HMM), linear discriminant analysis (LDA), k-means clustering, density-based spatial clustering of applications with noise (DBSCAN), random forest algorithm, support vector machine (SVM), or any model described herein. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

The process of “training” a machine learning model may include any steps used to prepare a machine learning model to perform some task. Often training involves determining or optimizing a set of “parameters” (which characterize the machine learning model) which result in acceptable model performance. Training can be performed in a series of “training rounds” during which training data is used to update the parameters of the machine learning model, for example, based on a loss value.

A “loss value” or “error value” may include any value that indicates the deviation between a result of some process, method, or function and an expected, desired, or correct result. For example, if a machine learning model can detect anomalies in a data set comprising 100 data values, 17 of which are anomalous, if the machine learning model only detects 15 the 17 anomalous data values, the loss value could comprises, e.g., 2 (17-15). Loss values can be used to train and evaluate the training of machine learning models, e.g., by optimizing machine learning model parameters by minimizing the loss value, using processes such as stochastic gradient descent or backpropagation.

A “hyperparameter” can include any value used to configure a machine learning model that is external to the machine learning model. Typically, a hyperparameter is set, and is not estimated or determined from the training data that is used to train the machine learning model.

A machine learning model may comprise multiple “sub-models” or “layers,” which may refer to parts of a larger machine learning system. For example, a machine learning model could comprise a long short-term memory layer (which itself can comprise multiple layers), in addition to an attention layer and a linear layer. Layers can sometimes be organized in series, such that the input to a machine learning system is processed by a first set of layers, which produces an output that is then processed by a subsequent set of layers, and so forth until the output of the machine learning model is produced by the final layer in the series.

### BRIEF DESCRIPTION OF THE DRAWINGS

FIG. 1 shows a diagram of an exemplary deep image.

FIG. 2 shows a model of a scaled dot-product attention layer and a multi-head attention model, without local attention.

FIG. 3 shows a diagram of a local region that can be used in local attention.

FIGS. 4A-4D show some examples of local regions according to some embodiments.

FIG. 5 shows an overview of a machine learning model according to some embodiments.

FIG. 6 shows an overview of a multiscale machine learning model according to some embodiments.

FIG. 7 shows a flowchart corresponding to a method of generating a deep image embedding according to some embodiments.

FIG. 8 shows an example of a single scale embedding sub-model according to some embodiments.

FIG. 9 shows an example of a ragged tensor according to some embodiments.

FIG. 10 shows a diagram of an local attention transformer according to some embodiments.

FIG. 11 shows a diagram of a local attention layer according to some embodiments.

FIG. 12 shows a diagram of a embedding sub-model comprising a multiscale network according to some embodiments.

FIGS. 13A-13D show examples of different bin dropout patterns used in some embodiments of the present disclosure.

FIG. 14 shows a diagram of an embedding sub-model comprising a sequence of multiscale networks according to some embodiments.

FIG. 15 shows a diagram of an embedding sub-model comprising a sequence of multiscale networks and temporal mixing transformers according to some embodiments.

FIG. 16 shows a flowchart corresponding to a method of denoising a deep image using a denoising sub-model according to some embodiments.

FIG. 17 shows a diagram of a denoising sub-model according to some embodiments.

FIG. 18 shows a diagram of a blur attention element according to some embodiments.

FIG. 19 shows a diagram of a denoise attention element according to some embodiments.

FIG. 20 shows a flowchart corresponding to a method of training a machine learning model to denoise deep images according to some embodiments.

FIG. 21 is a simplified block diagram of system 2100 for creating computer graphics imagery (CGI) and computer-aided animation that may implement or incorporate various embodiments.

FIG. 22 is a block diagram of computer system 2200.

### DETAILED DESCRIPTION

As described above, embodiments of the present disclosure are directed to methods, machine learning models, and systems (e.g., computer systems implementing said machine learning models) for denoising deep images, including deep Monte Carlo renderings. In order to orient the reader, some of these concepts are described below. These descriptions are intended facilitate a better understanding of embodiments of the present disclosure. These descriptions are not intended to be a complete treatment of machine learning, attention, deep images, animated film production, etc. It is assumed, generally, that a potential practitioner of embodiments already has some familiarity of these concepts.

A brief description of the workflow of producing and revising a rendered image (e.g., a frame of an animated film) of a scene, object, or character is provided herein. After a scene has been planned (e.g., by writers or directors, via storyboarding, etc.), a team of graphics artists can use 3D computer graphics software to compose that scene or individual objects or characters within that scene. The artists can place 3D objects and characters within a 3D workspace and define their size, shape, orientation to one another, material properties, etc. The artists can also define light sources and their properties, as well as other effects that may influence the appearance of the scene, objects, or characters (e.g., particle effects, such as smoke or dust). Additionally, the artists can define a camera perspective or viewpoint, which may define the appearance of any rendered images of that scene, object, or character.

After a scene (or an individual object or character) has been composed, the scene can be rendered, a process which generally comprises producing an image from the 3D scene, e.g., from the perspective of a defined camera perspective or viewpoint. Many 3D computer graphics software products have an associated render engine, or will enable rendering via a third-party engine via a programming interface. Such rendering engines enable images to be rendered in various formats, including both flat images and deep images (e.g., conforming to the OpenEXR format).

There are various rendering techniques that can be used to render images including deep images. Many of these techniques work by modeling light transportation, e.g., by modelling the emission of light from light sources, reflected off the surface of objects in a scene, and into the lens of a virtual camera corresponding to a camera perspective or viewpoint established by the artists composing the scene. In more detail, a computer system can determine the appearance of pixels in a rendered image by repeatedly sampling simulated rays of light emanating off the surface of objects in the image and passing through those pixels, which can correspond to different locations on the camera viewing plane. “Path tracing” is one such Monte Carlo method for rendering images that can realistically model the illuminance on modeled 3D objects. Path tracing can be used to produce photorealistic images when used with physically accurate object surface models.

As described above, a large number of samples per pixel (e.g., 5000 or more) are needed to produce high quality, noise free renderings. Unfortunately however, Monte Carlo rendering methods such as path tracing are computationally inefficient, and collecting enough samples to produce noise free renderings is often computationally infeasible, or can require several hundred hours of render time. This can be especially problematic when a large number of high resolution images need to be rendered, e.g., in an animated feature film. As such, for practical reasons, production teams often limit the number of samples in order to render images in a reasonable amount of time. This unfortunately results in rendered images that have visual noise, random speckling that is similar to film grain or television static. While noisy images can be used in later production stages, including compositing, production teams generally prefer noise free images in professional productions. In some cases, noisy images may be too low quality to be used in films, television shows, or videogames.

One solution to this problem is the use of denoising. Rather than using a large number of computing hours to generate a noiseless or nearly noiseless rendering, a noisy rendering can be generated relatively quickly and denoised using image processing techniques. Because denoising often takes significantly less time than rendering, rendering and denoising can often produce higher quality renderings more quickly and efficiently than rendering alone. In some productions, the combination of rendering and denoising can reduce the total render time by an order of magnitude (e.g., from 200 core computing hours to 20 core computing hours).

Because denoising Monte Carlo renderings has this impact on reducing rendering time, denoising Monte Carlo renderings has been an active area of research. Some previous work in denoising Monte Carlo renderings are identified below in the Patent Literature and References Section [10-18], including those based on machine learning. However, most denoising techniques focus on denoising flat images, and denoising deep images is a less studied problem. One example of a denoising method is Zhang et al. 2024 [18], which uses convolutional neural networks to denoise rendered deep images. By contrast, methods according to embodiments (described in more detail below) use machine learning with novel local attention mechanisms to denoise deep images, often achieving better results than existing denoising methods.

Regardless, after a noise free renderings are produced, digital artists can continue the process of film production, e.g., by performing compositing, a step in which different parts of a frame are post-processed, edited, or otherwise fine-tuned before being merged into a single image. In some cases, multiple elements of a scene may be rendered independently (e.g., moving characters in an animated film and static background objects) and compositing may be performed in order to combine those elements into a single image frame. Noise reduces the quality of the compositing operations and increases the difficulty of producing an aesthetically pleasing scene or visual effect, which is another reason why image denoising is useful in the production of animated films.

After frames are rendered and composited, they may be subject to review, e.g., by an art director. The art director may request changes to these frames. For example, the director may request that an artist change the lighting in a scene, the color of the scene, or add additional elements to the scene. There are a few ways in which this can be accomplished. As one example, rendered frames can be edited using image manipulation software. Using such software, artists have some control over the appearance of the frames. Artists can, for example, apply filters (e.g., a sepia filter) to change the color temperature of the frames, or “repaint” pixels to change the appearance of objects or characters. However, artists are somewhat limited in what edits they can perform using image manipulation software. For example, an artist cannot change the “camera angle” or point of view of the scene using image manipulation software.

As such, another way in which a frame can be edited is by recomposing and re-rendering the scene, or by recomposing and re-rendering individual elements of the scene (e.g., an individual character in the scene if characters and background objects are rendered separately). This process of composing, rendering, denoising, compositing, and editing can be repeated until directors or other stakeholders are satisfied with the image. Generally however, due to the time and cost of rendering, production teams generally prefer to spend less time rendering and re-rendering scenes, and consequently prefer to edit frames using image manipulation software when possible.

As such, artists, directors, and producers generally prefer when frames are rendered into an image format that gives artists greater ability to edit those frames using image manipulation software, obviating the need to re-render frames, and generally resulting in a higher quality end-product. As described in more detail below, deep images generally give artists more creative control than flat images. As such, artists, directors, and producers often prefer to work with deep images.

However, because denoising is so effective at improving the overall speed at which frames are rendered, directors and producers generally want frames rendered into an image format that can be denoised effectively. Prior to methods according to embodiments, flat image denoisers generally outperformed deep image denoisers, which often did not achieve satisfactory denoising quality. As such, the lack of deep image denoising methods that compete with flat image denoisers is a problem preventing the use of deep images in production. For these reasons, production teams typically work with flat images, rather than deep images, even though artists, directors, and producers would generally prefer to work with deep images. However, by providing efficient, high-quality deep image denoising methods, embodiments of the present disclosure address these problems and enable production teams to render and use deep images in production.

### I. DEEP IMAGES

As embodiments of the present disclosure relate to methods for denoising deep images, a brief description of some concepts related to images, deep images, and their structure is provided below.

There are various digital image formats used in computer systems and on the Internet. However, most digital images comprise raster images or are eventually converted into raster formats, in order to be displayed on computer screens or other devices. As described above, raster images typically comprise two dimensional arrays of grid cells, often referred to as “pixels”. Most raster images are “flat” raster images, in which each grid cell comprises exactly one pixel. In such flat raster image, each pixel can contain data that defines the visual appearance of that pixel in the image, such as red, green, and blue color values, opacity values (e.g., from an alpha channel), etc. When viewed as a whole, the entire grid of pixels resembles the subject of the image. Although the term “flat” implies a two dimensional structure, a flat RGBA raster image could be represented by a three dimensional matrix, e.g. a n×m×4 matrix, where n and m are the dimensions of the image (e.g., 1920 by 1080), and the four levels correspond to the red, green, and blue color values and alpha (opacity) values. The inclusion of alpha information can enable flexible compositing after rendering, e.g., by enabling images to be “stacked” on one another, such that the transparent pixels (e.g., pixels with a low alpha value) do not occlude background pixels.

Flat image data can be organized into “channels” and “layers”. In general, a channel can refer to some collection of data of a common data type in the flat image. For example, the “blue color channel” in a flat RGB image can comprise all of the blue color values that contribute to the color of the pixels in the image. Generally, layers can further compartmentalize data corresponding to the flat image. For example, for a flat RGBA image, a “color layer” can contain the three color channels (i.e., red, green, and blue color channels), while an “alpha layer” can contain a single alpha channel. A flat image is “non-ragged” in the sense that every grid cell has associated values for each applicable channel, e.g., a pixel in a flat RGB image will always have red, green, and blue color channels. As such, flat images can be represented by “complete” matrices. As described below, this makes flat images well-suited to image processing techniques such as convolution.

Another less common type of raster image is the “deep” raster image. A deep image can also be represented by a rectangular matrix or grid. However, unlike a flat image, in which each grid cell is associated with a single pixel, each grid cell in a deep image can be associated with any number of “bins,” and grid cells are not required to contain the same number of bins. Deep images in film production often comprise between 0 and 25 bins per grid cell, but can comprise more, e.g., 64 or more bins. The “bin layout” of a deep image can define the number of bins in each grid cell. Typically, the term “pixel” in a deep image refers to an individual grid cell, rather than a bin corresponding to that grid cell.

Generally, these bins can contain information that would be associated with a pixel in a flat image, e.g., red, green, and blue color channel data, alpha data, etc. When displayed (e.g., on a computer screen), the information in all bins corresponding to a grid cell may inform the appearance of a corresponding pixel, and as such, the bins as a whole may inform the appearance of the deep image. Like flat images, deep images may also comprise layers, and bins may be organized in these layers, correspond to layers, or contain information corresponding to multiple layers. For example, a deep image may have diffuse, specular, and albedo layers, each of which may have their own channels, such as red, green, blue, alpha, and depth channels.

A bin may, for example, correspond to a given layer. For example, a bin may comprise a data structure such as [Layer: “Color”, Value: 255, 255, 255], indicating that the bin corresponds to a color layer and defines three color values. Such values may also be referred to as “layer values”, i.e., values associated with a given layer of a deep image, including values associated with a channel within that layer. Alternatively, a bin may correspond to a given channel within a layer, e.g., just the alpha channel of an albedo layer. As another alternative a bin may contain information corresponding to multiple layers and channels, e.g., a bin may possess data values corresponding to each channel in each layer of a deep image. Other alternative structures and configurations of deep images, bins, layers, and channels are also possible, and the examples provided above are intended to be non-limiting.

As with flat images, there are various methods by which the data in a deep image may be divided among layers and channels. A deep image comprising red, green, and blue color channels, along with an alpha channel could be structured as single layer deep image. Alternatively, it could be structured as a two layer deep image with a color layer (with three color channels) and an alpha layer with a single channel. As described below, in some denoising methods according to embodiments, it may be preferable that data such as color data and alpha data is relegated to separate layers, as better denoising quality may be achieved by denoising these layers independently.

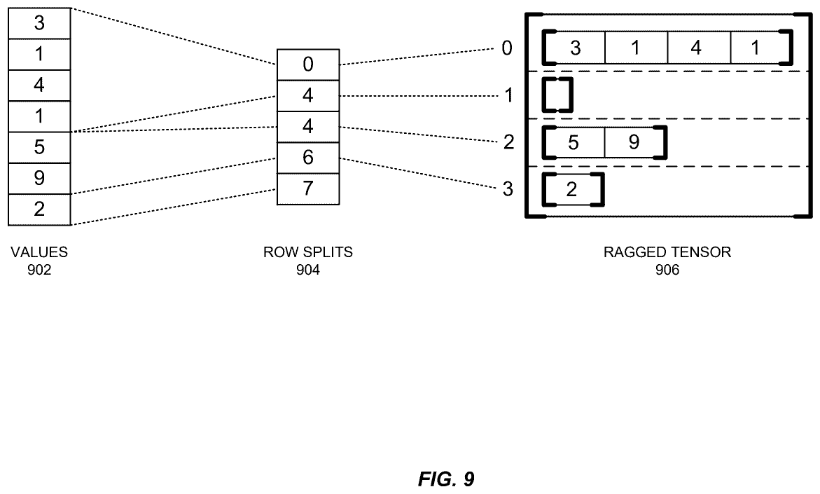

Deep images may conform to the OpenEXR standard for deep images or any other appropriate standard. Some standards may require particular deep image structures or the presence of particular channels, such as alpha and depth channels (although such standards may permit, e.g., constant value channels, such as a depth channel for which all bins have a depth of “0”). Although the structure of deep images is described above in terms of some array of grid cells, each comprising some variable number of bins, it should be understood that the structure of a deep image, as it may be understood by people or visualized on a computer screen, may be different from its actual form in computer memory. As one example, a deep image can be represented by a by a ragged tensor in a “row-split” format, e.g., as described below further below with reference to FIG. 9.

As each grid cell in a deep image can contain a different number of bins, the topology of deep images can be highly non-uniform and vary considerably between deep images. As such, deep images are considered to be “ragged”, “jagged”, or “irregular” data structures. Denoising methods that are effective on non-ragged flat images cannot be easily adapted to deep images because of their raggedness. As a result deep images are more difficult to denoise using existing denoising methods, such as convolutional neural networks, as such methods require a regular arrangement of data (e.g., in the form of a “complete” “non-ragged” matrix) in order to perform operations such as the discrete convolution. As such, considerable pre-processing is needed to denoise deep images using convolutional neural networks. In some cases, data needed to perform this pre-processing (e.g., data that can be used to organize bins into a regular array) may not be available in deep images.

There are various categories and classes of deep images, including those that are based on how those deep images are “binned.” The “binning” of a deep image can generally refer to what data is associated with bins, as well as the structure of the deep image in view of the bins and the data associated therewith. For example, a deep image “binned” based on depth may comprise bins that contain depth information. A data structure corresponding to the deep image may be organized based on depth, e.g., such that bins are organized by ascending depth. Alternatively or additionally, such a data structure could facilitate sorting or organizing the bins based on depth, or facilitates the identification and selection of bins based on their depth.

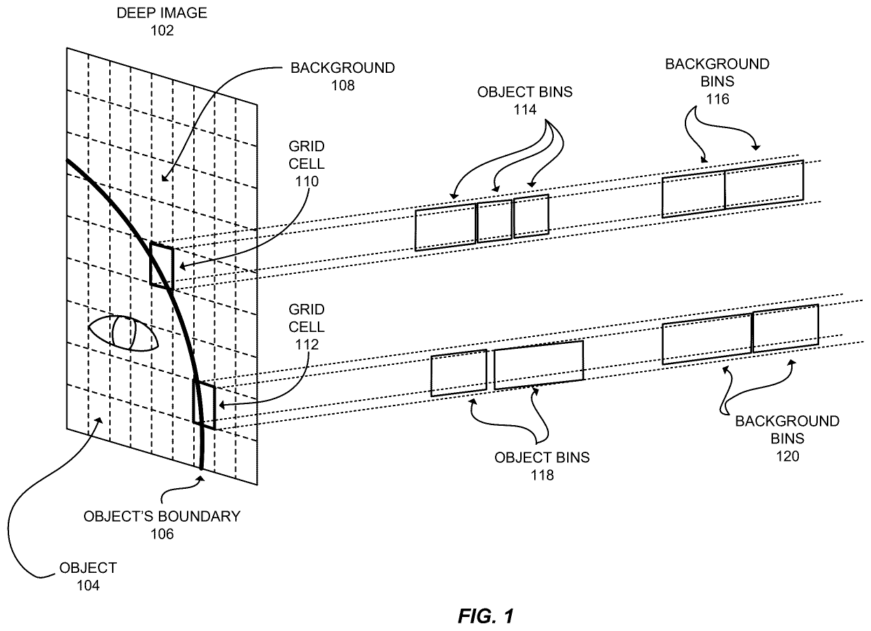

Two types of deep images are “Deep-Z” images and “Deep-Object-ID” images. Deep-Z images are binned based on depth, e.g., as described above, and each bin can represent a section of a pixel-frustrum bounded by depth. Deep images, particularly Deep-Z images, may be better understood with reference to FIG. 1, which shows an exemplary Deep-Z image 102.

Deep image 102 depicts an object 104 (i.e., a face) in front of a background 108. The appearance of the deep image 102 corresponds to the bin contents of the grid cells making up the deep image 102. While some grid cells may correspond exclusively to the object 104 or the background 108 (and therefore contain bins corresponding to only the object 104 or the background 108), other grid cells may contain bins corresponding to both the object 104 and the background 108. This may be the case for grid cells located on the object's boundary 106, such as grid cells 110 and 112, as the object 104 may only partially occlude the background 108 at the object's boundary 106.

FIG. 1 shows an expanded view of grid cells 110 and 112 and their respective bins. As deep image 102 comprises a Deep-Z image, these bins are organized based on depth, visualized in FIG. 1 as a clustering of object bins and background bins on the z-axis. Grid cell 110 comprises object bins 114 corresponding to the object 104, and background bins 116 corresponding to elements of the deep image that are in the background 108 behind the object 104. Grid cell 112 likewise comprises object bins 118 and background bins 120.

In contrast to Deep-Z images, Deep-Object-ID images are binned based on object identifiers, and the bins in a Deep-Object-ID image may contain object identifier data values. The bins in a Deep-Object-ID image can be organized based on such object identifiers (e.g., bins corresponding to the same object identifiers may be stored in contiguous regions of memory), and a Deep-Object-ID image may facilitate the identification and selection of bins based on object identifiers. Such object identifiers can identify objects with which bins are associated, e.g., objects that were composed independently in three dimensional computer graphics software. For example, for a scene depicting a tree and a rock, object identifiers may identify whether a particular bin represents samples (e.g., generated during rendering) that are associated with the appearance of the rock or the tree in the scene.

Although Deep-Z images are binned based on depth, it should be understood that some Deep-Z images can contain object identifier data. Likewise, some Deep-Object-ID images can contain depth data. However, it should be understood that a particular type of deep image does not necessarily contain information corresponding to the binning of another type of deep image, i.e., it should not be assumed that all Deep-Object-ID images contain depth information.

As mentioned above, deep images are generally more difficult to process (e.g., denoise) with convolutional neural networks or other convolution based techniques due to their raggedness. Deep images have to be converted into a regular matrix in order to perform convolution operations. In some cases, it is possible to use depth information (e.g., in Deep-Z images) in order to organize the bins in such a matrix and pad the matrix so that it is regular, e.g., as described by Zhang et al. 2024 [18].

However, Deep-Object-ID images may not possess such depth information. As such, it can be difficult or impossible to initially process Deep-Object-ID images for denoising using convolutional neural networks. As such, Deep-Object-ID images are more difficult to denoise than Deep-Z images, and many existing deep image denoising methods are not applicable to Deep-Object-ID images. Methods according to embodiments however, can be used to denoise both Deep-Z and Deep-Object-ID images, making them a flexible solution to the problem of denoising deep images.

As stated above, artists and production teams generally prefer to work with (e.g., edit and composite frames with) deep images instead of flat images. Deep images can provide more visual fidelity than flat images due to variable numbers bins per grid cells, particularly near the edges of objects in images, e.g., where an object in the foreground may be partially occluding an object in the background. As a result, deep images tend to have more accurate opacity and less visual artifacts near the edge of objects in compositing because the variable bins offer ideal separation of geometric boundaries.

Additionally, artists prefer working with deep images over flat images because they provide greater creative control for editing and revising rendered scenes. In very general terms, the additional bins in deep images, the additional data associated with those bins, and the binning of those deep images enables artists to manipulate deep images in ways that are not possible in flat images.

For example, for a Deep-Object-ID image, an artist can use image manipulation software to select only the bins corresponding to particular objects. The artists can mask out or “lock” unselected bins, then use the image manipulation software to modify the object by modifying the selected bins (e.g., changing the color of the object, modifying the texture of the object, etc.) without affecting other objects within the scene. In this way, the artists may be able to fix issues with particular objects or characters in a scene without requiring those characters or the entire scene to be re-rendered, a process that may be time-consuming or costly.

This is generally not possible for flat images, which do not contain bin information. An artist cannot selectively modify bins that contribute to the appearance of a pixel. Instead, the artist can only modify the pixels themselves, which is a generally labor intensive process. When editing a flat image, an artist cannot select and edit bins corresponding to a specific object or a specific depth plane, preventing an artist from, e.g., only editing an object in the foreground or background.

As such artists and production teams generally prefer to work with deep images over flat images. However, as described above, because state-of-the-art flat image denoisers typically outperform state-of-the-art deep image denoisers, and because of the impact denoising has on rendering efficiency, productions often use flat images rather than deep images in production. By providing for efficient high quality deep image denoising methods, embodiments of the present disclosure enable production teams to use deep images in production.

### II. MACHINE LEARNING

Some deep image denoising methods according to embodiments use machine learning. As such, a brief summary of machine learning is provided herein, in order to better orient the reader.

Machine learning models are often defined by sets of parameters, which generally control how the machine learning model produces output data responsive to received input data. As an example, a support vector machine (SVM) is a type of machine learning model that divides data points using a hyperplane. Data on one “side” of the hyperplane is classified as one class (e.g., normal) while data on the other side of the hyperplane is classified as another class (e.g., anomalous). The parameters of the support vector machine can comprise the coefficients used to define the hyperplane. Changing these parameters changes the shape of the hyperplane, and thus changes which data points the SVM classifies as normal or anomalous.

In broad terms, the process of training a machine learning model can involve determining the set of parameters that achieve the “best” performance, usually based on a loss or error function. A loss function relates the expected or ideal performance of the machine learning model to its actual performance on a (typically labeled) training data set. The loss function typically decreases in value as the model's performance improves. As such, training a machine learning model often involves determining the set of parameters that minimize a loss function corresponding to that model. Sometimes a random parameter estimate is generated as an initial parameter “guess,” and then a process such as gradient descent is used to iteratively refine the parameter estimate, eventually resulting in a final set of parameters associated with the machine learning model.

This iterative refinement process can be performed in a series of training “rounds”, “epochs”, or other appropriate divisions. In each round, a machine learning model's performance can be evaluated using the loss function, and the parameters can be updated based on this evaluation, e.g., with the goal of reducing the reducing the result over time. As an example, the gradient of the loss function can be determined in parameter space and can be used to reduce the value of the loss function in successive training rounds. Such a gradient corresponds to a change in model parameters that achieves the greatest immediate reduction in the loss function. By changing the model parameters based on the gradient, the loss function can be reduced during each successive training round. This process can be repeated until a terminating condition has been met. In embodiments of the present disclosure, one type of terminating condition is a defined number of training rounds. This terminating condition can be met if the number of training rounds performed (e.g., by a computer system training the machine learning model) equals or exceeds the defined number of training rounds, at which point the iterative training process has been completed. Another type of terminating condition in embodiments is a convergence condition. This terminating condition can be met if the machine learning model parameters “converge.” In broad terms, convergence is achieved when the value of the loss function, and/or the values of the model parameters change in increasingly small amounts with each successive training round. For example, a convergence condition can be achieved if the value of the loss function decreases by less than 0.1% in two successive training rounds.

As described in more detail below, some methods according to embodiments use a machine learning model comprising an embedding sub-model and a denoising sub-model. Each sub-model can have its own parameter set, and parameters of the machine learning model can collectively comprise the parameters of all the sub-models. In some embodiments, each sub-model can be trained simultaneously based on a combined loss function, i.e., each set of parameters for each sub-model can each be updated in each training round.

### A. Convolutional Neural Networks

As described above, embodiments of the present disclosure are directed to methods, machine learning models, and systems for denoising deep images. Such methods use novel local attention mechanisms to denoise deep images. Attention and local attention are described in more detail further below. While embodiments of the present disclosure do not use convolutional neural networks, some state of the art approaches to denoising deep images (e.g., Zhang et al. 2024 [18]) do use convolutional neural networks. These convolutional neural networks have some weaknesses with regard to denoising deep images. Embodiments of the present disclosure do not have these weaknesses because they use local attention instead of convolutional neural networks. As such, a brief description of convolutional neural networks and the convolution operation may be useful for understanding novel aspects and technical advantages of embodiments of the present disclosure.

In more detail, a convolutional neural network is a machine learning model often used in image processing. A convolutional neural network typically involves an alternating series of convolution layers and pooling layers, followed by a fully connected neural network layer. The convolution layers implement an operation known as the “discrete convolution”. The discrete convolution predates the convolutional neural network, and has seen widespread use in signal processing, particularly in the field of image processing. This is because, in part, various useful or desirable image processing operations, such as sharpening or blurring images can be implemented relatively easily using discrete convolutions.

In the context of convolutional neural networks, because the convolution operation is typically applied to small subsections of the image, rather than the entire image, the use of convolution greatly reduces the number of computations that need to be performed when compared to a “direct application” of a neural network to an image. As a result, convolutional neural networks can be trained more quickly, can be characterized by smaller and less memory intensive parameter sets, and typically achieve better performance for similarly sized parameter sets.

In brief and as an example, in the discrete convolution operation, a “convolution kernel” may be applied to an image subject to convolution. The image may be represented by a matrix, and the convolution kernel may also comprise a matrix that is typically much smaller than the image matrix. The convolution kernel may be scanned across the rows and columns of the image matrix. At each location, the discrete convolution can be computed between the convolution kernel and a “sub-matrix” of the image matrix located at that location, producing a scalar output for each location. The result of the discrete convolution applied to the entire image is a matrix comprising these scalar outputs. It should be understood that convolutions can be for various tasks other than image processing, and that many varieties of convolution kernels can be used. In some tasks (e.g., signal processing and filtration) a one dimensional convolution kernel may be used instead of a two dimensional convolution matrix. Likewise, in the CNN-based image denoiser of Zhang et al. 2024 [18], three dimensional convolutions are performed and a three dimensional convolution kernel is used instead of a two dimensional convolution matrix.

Convolution is useful in image processing because different image processing operations can be performed by changing the numerical elements of the convolution kernel, e.g., by using different values in the convolution kernel, the discrete convolution operation can be used for both blurring images and sharpening images. In convolutional neural networks, the convolution kernel may comprise learnable parameters. In some cases, all elements of the convolution kernel (e.g., numerical elements of a matrix representing the convolution kernel) may be learnable. As such, a convolutional neural network can effectively learn to perform whichever convolution-based image processing operation is needed to perform the function implemented by the convolutional neural network (e.g., denoising deep images).

Notably, the convolution operation is only defined for numerical values of a matrix (e.g., an image matrix), which means that each element of the matrix needs to be defined. Hence ordinary convolution operations cannot be directly performed on ragged data structures such as deep images without first processing those deep images such that they are represented by complete matrices. As described above, this makes it difficult to process (e.g., denoise) deep images using convolutional neural networks.

Extending flat image denoising methods to deep images (e.g., by applying 2D denoising on each bin layer by depth) leads to artifacts due to misalignment by bins. Many previous methods of convolution-based denoising relied on the index of image elements (e.g., pixels) in order to define regions of elements on which the discrete convolution operation would be performed. In deep images however, bins within neighboring pixels may be very far away from each other (e.g., due to different depth values, e.g., for “neighboring” bins corresponding to the foreground and background of an image), which could result in the bin misalignment mentioned above. Zhang et al. 2024 addressed this problem using depth information in Deep-Z images identify bins that are likely spatial neighbors, e.g., bins that are both in neighboring pixels and have similar bin depth, thereby reducing or eliminating misalignment artifacts.

While this method achieved good denoising quality (although still worse than methods according to embodiments), it is only applicable when depth information is available, which may not be the case for Deep-Object-ID images as described above. As such, this method cannot be used to denoise deep images without depth information. By contrast, embodiments of the present disclosure use a novel form of local attention (rather than convolutional neural networks) to denoise deep images. These local attention methods can be applied to ragged data structures (e.g., deep images) without requiring those ragged data structures to be converted to a regular matrix. As such, depth information is not needed to perform methods according to embodiments. Attention and local attention are described in some detail below.

### III. ATTENTION

Because attention (but not local attention) is a generally well-understood concept in the field of machine learning, it is assumed that a potential practitioner of embodiments of the present disclosure is familiar with the concept of attention. However, in order to facilitate a better understanding of local attention and embodiments of the present disclosure, a brief summary of attention is provided below. More information about attention can be found in the literature, e.g., in the article “Attention is all you need” [9].

Generally, attention is a “set to set” (or “sequence to sequence”) operation. That is, for a set of e.g., ten input vectors, the output of an attention operation may comprise a set of ten output vectors. Two notable types of attention, self-attention and cross-attention, are described below. Generally, in self-attention, the attention can be computed between a single input set and itself. In cross-attention there can be multiple input sets, and the attention can be computed between these input sets to produce the output set.

Attention is often used in the context of language models, in which each “token” (e.g., data representative of a word or part of a word, such as the suffix “-ing”) in a sequence (e.g., a sentence) can “interact” with each other token in the sequence for the purpose of performing the task associated with the language model. This is in contrast to previous types of machine learning models, such as recurrent neural networks, which have a temporal window and incremental interaction. Using attention, language models can learn which tokens interact with which other tokens, to which degree, and how, enabling such language models to learn the relationships between words in sentences. Language models that use attention often achieve better performance than language models that use recurrent neural networks, as they can model more complex relationships between input tokens in sentences.

In more detail, in self-attention, each output in the output set can comprise a weighted average of the inputs in the input set, e.g., for inputs in input set xᵢ and outputs in output set yᵢ, yᵢ=Σⱼw_{i,j}xᵢ. However, unlike other machine learning models based on weighted averages, in which weights are parameters of the system, the weights w_{i,j} in self-attention are often derived from a function of the inputs in the input set, often based on similarity, such that the weight corresponding to a pair of similar inputs may be greater than the weight corresponding to a pair of dissimilar inputs. Often, for sets of vector inputs, the weights are derived from the dot product between vector inputs, e.g., w_{i,j}=xᵢ·xⱼ, and in some cases, functions such as the softmax function can be used to map the weights to a defined range, such as [0, 1], i.e.:

$${w}_{i , j} = \frac{{e}^{{x}_{i} \cdot {x}_{j}}}{{\sum }_{j} {e}^{{x}_{i} \cdot {x}_{j}}}$$

Cross-attention is similar to self-attention, except the attention is not computed between members of a single set, but rather between members of multiple (often two) sets. In such cases, the cross-attention weights may be based off the dot products of different sets of inputs, rather than a single set.

Attention operations are often framed in the context of “queries”, “keys”, and “values”. For example, in a case of self-attention, queries qᵢ, keys kᵢ, and values vᵢ can be derived from inputs xᵢ via a query matrix W_{q}, key matrix Wₖ, and value matrix Wᵥ, e.g.:

$${q}_{i} = {W}_{q} {x}_{i} {k}_{i} = {W}_{k} {x}_{i} {v}_{i} = {W}_{v} {x}_{i}$$

$${y}_{i} = {\sum }_{j} softmax ( {q}_{i} \cdot {k}_{j} ) {v}_{j}$$

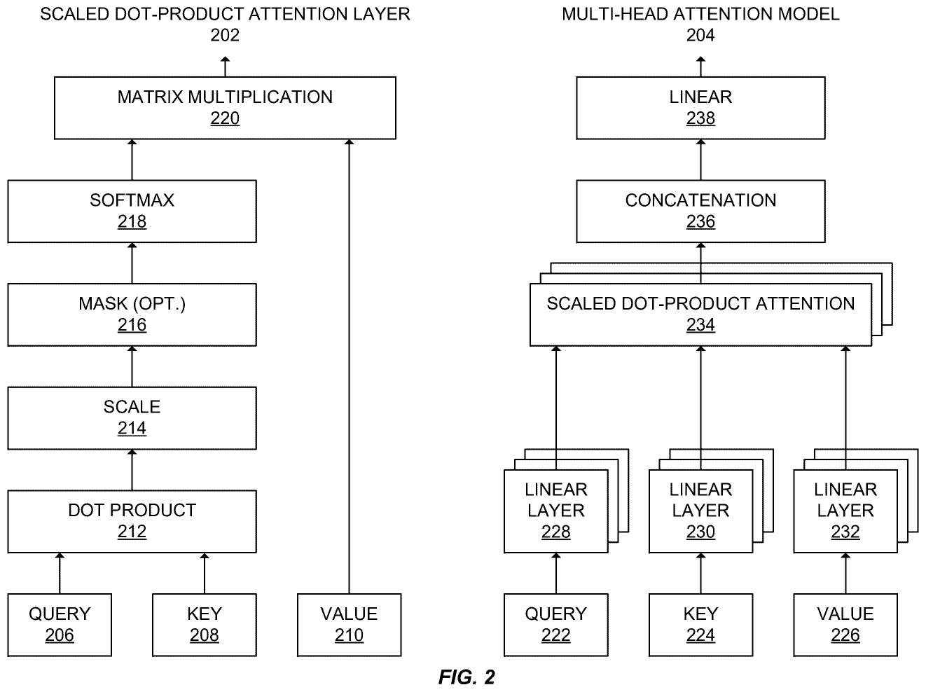

These weight matrices can be controlled in order to modify any input vectors based on the machine learning task being performed. In addition, the query, key, value framing of attention can be useful for implementing cross-attention, e.g., by deriving the queries, keys, and values from different input sources. Attention and the query, key, value framing may be better understood with reference to FIG. 2, which shows an example of a scaled dot-product attention layer 202 and a multi-head attention model 204. FIG. 2 is adapted from figures from “Attention is all you need” [9].

The scaled dot-product attention layer 202 can compare each input token (query 206) with every token (key 208) in a sequence (for self-attention) or every token in another sequence (for cross-attention) by using a dot product 212. The result can be scaled (214), optionally masked (216), and fed into a softmax function (218) to create weights for each query with respect to each key, which may sum to one as a result of the softmax function. These weights can be applied to the value of each key (matrix multiplication 220), which can then be summed up, creating an output value for each query (yᵢ, as described above).

FIG. 2 also shows an example of a multi-head attention model 204. In multi-head attention, multiple scaled dot-product attention layers 234 (corresponding to the “heads”) can be used in parallel and the results can be concatenated (236) before being applied to a linear layer 238. Each head can process the same query 222, key 224, and value 226, but can transform these data with its own linear layers (e.g., linear layers 228-232). In general, in single head attention, inputs in the input set can influence outputs by different amounts, but cannot influence those outputs in different ways. By using multiple self-attention heads, each with their own linear layers and/or weight matrices, attention-based machine learning models can have greater discrimination and accuracy.

Attention can be useful in a variety of machine learning tasks, particularly when the output of the attention operation can be mapped to a corresponding task output. For example, an AI customer service chatbot may comprise a sub-model used to determine the emotional sentiment (e.g., happiness, anger, etc.) behind a chat message received from a customer, in order to determine an appropriate response. If the output of a self-attention mechanism can be mapped to a “sentiment values” (e.g., by averaging and down-projecting self-attention outputs), then self-attention may be useful for this machine learning task.

More generally, attention can be used to reduce the problem of learning to perform a particular task to the problem of learning to generate “embeddings” that, when attention is applied to these embeddings, produce outputs that can be mapped to the desired outputs of the particular task. In the context of evaluating the sentiment of customer chat messages, training data could comprise pairs of messages and sentiment scores (e.g., “I am very angry” and “0”), and the machine learning sub-model could learn to generate vector embeddings from the messages (e.g., corresponding to individual words or parts of words) that, when self-attention is applied to those embeddings, result in outputs that can be mapped to the sentiment score (e.g., by averaging and down-projecting). Such embeddings can be generated using a linear layer (e.g., a neural network). The loss or error can be related to the difference between the actual and expected sentiment scores, which can be used to update the parameters of the linear layer used to generate the embeddings, e.g., such that it produces embeddings that result in attention outputs corresponding to accurate sentence sentiment. In this way, an attention-based machine learning model can be trained to perform tasks such as sentiment classification.

A “transformer” generally refers to a machine learning model that uses attention as the primary (or in some cases, only) interaction between input data units (e.g., tokens from an input sentence) in order to perform a particular task. Such transformers often combine attention mechanisms with dense layers (e.g., linear layers) for feature embedding along with residual connections, and have served as the basis for many recent neural networks, including those used in Large Language Models (LLMs).

Unfortunately however, because each token in self-attention or token embedding can attend to any other token (or token embedding) in the same set, attention scales quadratically with the size of input sets. In order to compute the query, key, and value, both the rows and columns in dot-product weight matrices W_{q}, Wₖ, and Wᵥ should be equal to the number of tokens in the set. As a result, the total number of elements in these matrices grow as the square of the number of tokens in the input set (i.e., quadratically).

Generally, when denoising a particular “focal bin” of a deep image, conventional attention would involve a machine learning model attending to all other bins in that deep image. Due to quadratic scaling and the generally large size of deep images, using attention in this matter would require extremely large weight matrices. As a result, conventional attention mechanisms are generally impractical for denoising deep images. This is one reason systems other than attention based transformers, such as convolutional neural networks (CNNs), are often used for denoising images. However, as described in more detail below, novel local attention mechanisms according to embodiments enable highly efficient deep image denoising and typically outperform state-of-the-art methods based on convolutional neural networks.

### A. Local Attention

In general terms, the difference between local attention and attention, as summarized above, is that in local attention an attention layer can only attend to tokens within a given local region, rather than attending to all tokens within an input set or sequence. In the context of denoising deep images, a machine learning model according to embodiments can attend to bins within a given local region, rather than attending to all bins in a deep image.

Local attention may be better understood with reference to the formulas that were described above:

$${q}_{i} = {W}_{q} {x}_{i} {k}_{i} = {W}_{k} {x}_{i} {v}_{i} = {W}_{v} {x}_{i}$$

$${y}_{i} = {\sum }_{j} softmax ( {q}_{i} \cdot {k}_{j} ) {v}_{j}$$

As in standard attention, local attention can be implemented with a dot-product between the query embeddings (after an optional linear layer) and key embeddings (also after an optional linear layer). However, in local attention, instead of all query embeddings attending to all key embeddings, query embeddings can only attend to keys within a local region. Expressed in other words, while in standard self-attention summation over j in the above formulas is a summation over all the tokens used to derive the query, key, and value (e.g., all of the bins in the deep image). By contrast, in local attention, summation over j is a summation over only the tokens corresponding to the local region.

The use of local attention solves the quadratic scaling problem described above, and enables attention based denoising of deep images. As the size of local regions is generally small relative to the size of the deep image, machine learning models according to embodiments are considerably less affected by quadratic scaling. Further, local attention is well-suited for denoising deep Monte Carlo renderings, as Monte Carlo noise is generally a local phenomenon. In a noisy Monte Carlo rendering, the global structure of the image is generally correct, but individual bins scattered throughout the image are noisy and incongruent with local neighboring bins. As such, when denoising a given focal bin, bins close to that bin (e.g., within a same local region) may be relevant for denoising the focal bin, while bins far away from the focal bin (e.g., outside the local region) may have little relevance. As such, by attending only to local bins, machine learning models according to embodiments enforce computation locality and avoid performing a large number of computations on likely irrelevant distant bins. Hence, by using local attention rather than global attention, little is lost from excluded distant bins, while much is gained in terms of efficiency.

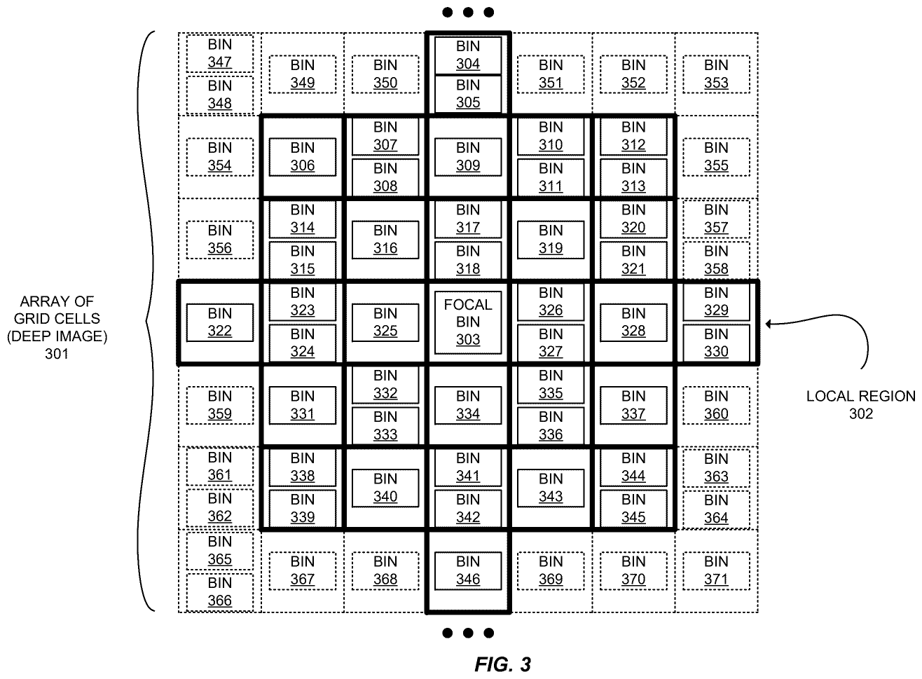

FIG. 3 may be helpful in understanding the concept of local attention. FIG. 3 shows a segment of an array of grid cells 301 (i.e., comprising a small section of a deep image). Each grid cell contains one or more bins, however it should be understood that in some deep images, a given grid cell (pixel) may contain zero bins. FIG. 3 also shows a local region 302 centered on a focal bin 303. The local region 302 contains focal bin 303, as well as bins 304-346. Bins 347-371 are located outside the local region 302. In embodiments of the present disclosure, a focal bin embedding can be determined for focal bin 303 based on attention between focal bin 303 and the other bins in the local region 302, without considering bins outside the local region 302, e.g., bins 347-371 (and other bins in the array of grid cells 301 that are not depicted in FIG. 3). As discussed above, by attending only to a subset of bins in the deep image (i.e., bins within local region 302), rather than all bins in the deep image, embodiments of the present disclosure are not as impacted by quadratic scaling, and can therefore leverage attention for deep image denoising, for which conventional attention is generally infeasible.

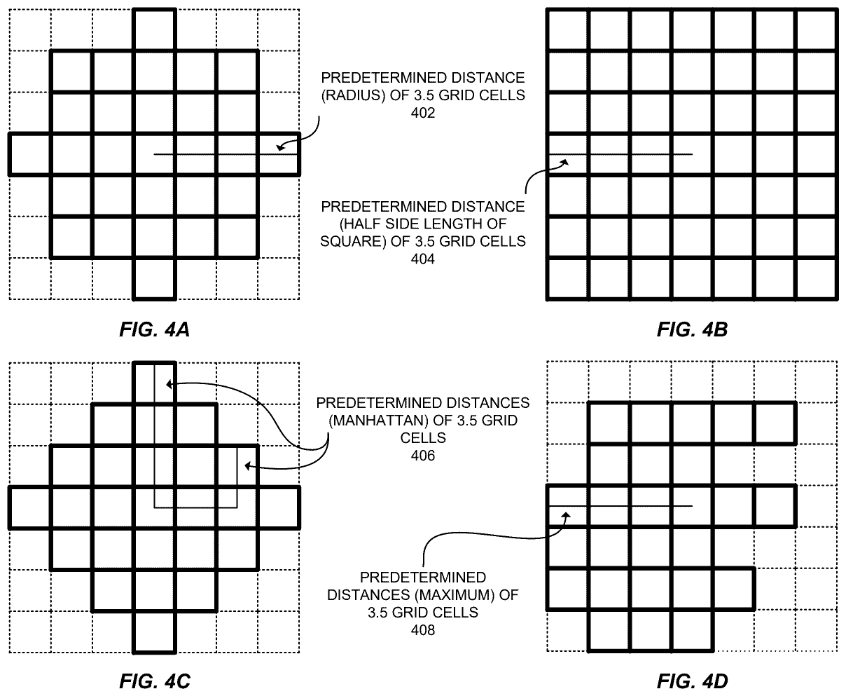

FIG. 3 depicts a local region 302 with a radius of 3.5 grid cells. Such approximately circular regions may be effective for local attention denoising methods according to embodiments. However, it should be understood that any type, shape, or size of local region can be used in methods according to embodiments. A non-exhaustive set of examples described below with reference to FIGS. 4A-D.

FIG. 4A shows a circular local region defined by a predetermined distance 402 of 3.5 grid cells (i.e., a radius). FIG. 4B shows a square local region defined by a predetermined distance 404 of 3.6 grid cells (i.e., half of a side length of the square). The local region of FIG. 4B contains more grid cells than the local region of FIG. 4A, and therefore may lead to more accurate denoising. However, the local region of FIG. 4B likely contains more bins than the local region of FIG. 4A, and therefore requires more memory and computation time to compute the attention. FIG. 4C shows a local region defined by a predetermined distance 406 of 3.5 grid cells (in this case, a “Manhattan” or “taxicab” distance from a central grid cell to the edge of the local region. FIG. 4D shows a non-symmetrical local region defined by a predetermined distance 408 of 3.5 grid cells. In this case, the predetermined distance relates comprises the greatest distance from the center grid cell to an edge grid cell. An irregular local region, as depicted in FIG. 4D, may be suitable for deep images that have repeating patterns or structures similar to the structure of the irregular local region. For case of exposition, FIGS. 3 and 4A-4D show two dimensional local regions. However, it should be understood that local regions can comprise more than two dimensions and can comprise various three (or more) dimensional shapes. For example, a spherical local region could contain grid cells (and bins corresponding to those grid cells) within a specified radius of a focal bin in three dimensions. Likewise, a conic local region could contain grid cells (and bins corresponding to those grid cells) within a cone, defined e.g., by a circle projected from a rendering camera viewpoint.

There are several advantages of using local attention based methods according to embodiments for denoising deep image over current state-of-the-art methods that use convolutional neural networks. One advantage is that methods according to embodiments are flexible, in that they do not require any particular features to denoise deep images. Unlike deep image denoising methods using convolutional neural networks, embodiments of the present disclosure do not need depth information.

Further, unlike deep image denoising methods using convolutional neural networks, machine learning models according to embodiments can be applied to deep images with arbitrary bin topologies, without requiring conversion to a dense representation or a complete matrix. This is because transformers and attention layers are indifferent to the raggedness of input sets. As such, in addition to denoising Deep-Z images, embodiments of the present disclosure can be used to denoise Deep-Object-ID, including Deep-Object-ID images without correct depth information, which is not possible for 3D convolution based deep image denoising methods.

Additionally, embodiments of the present disclosure can be used to denoise deep images with only color information and alpha (e.g., without other data such as albedo or specular data), without the need of lighting or other features, or with varying combinations of features. Hence embodiments of the present disclosure are better suited to denoise deep images than methods based on convolutional neural networks. This flexibility makes it convenient to implement methods according to embodiments in production workflow.

Additionally, embodiments of the present disclosure achieve better denoising quality than existing convolutional neural network based image denoisers. By improving denoising quality, embodiments of the present disclosure enable artists to use deep images in production rather than flat images, an arrangement that is generally preferred by artists and production teams.

Further, as described in more detail further below, embodiments of the present disclosure can also be adapted to perform temporal denoising on sequences of deep images in addition to spatial denoising.

### IV. MODEL OVERVIEW

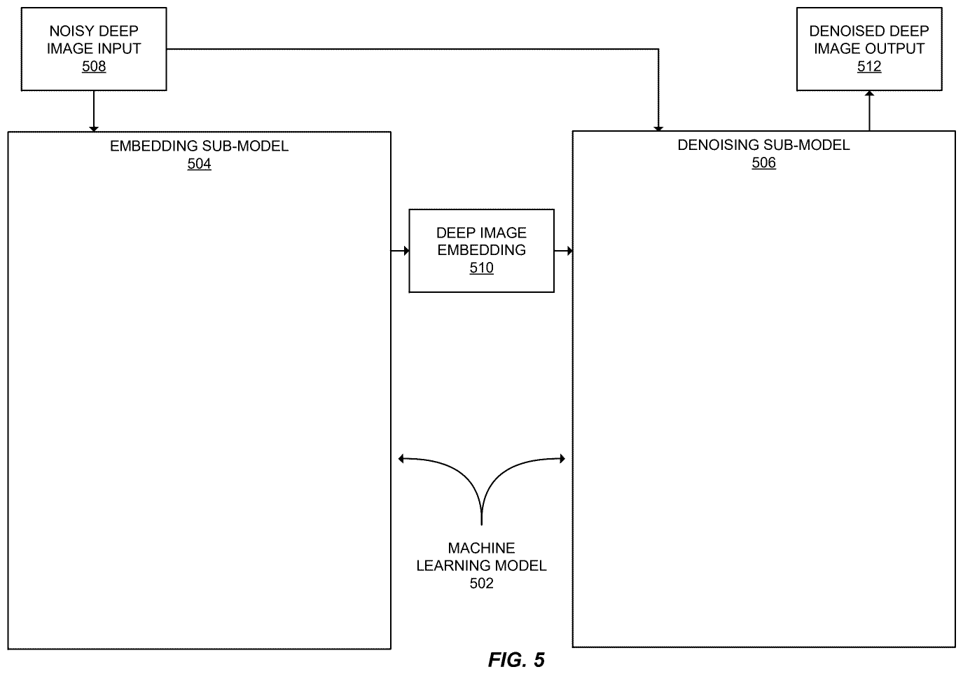

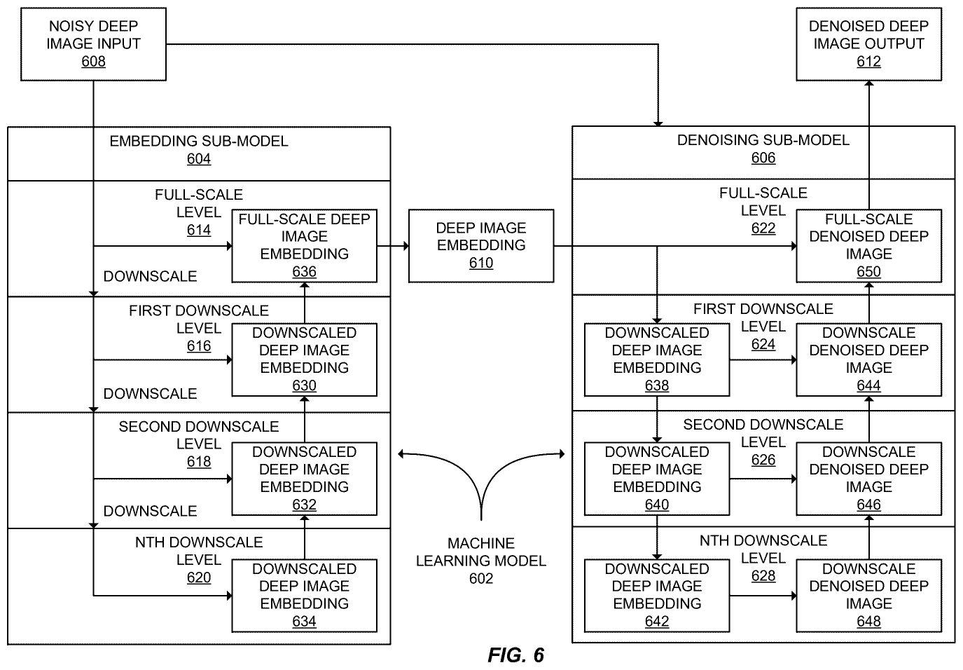

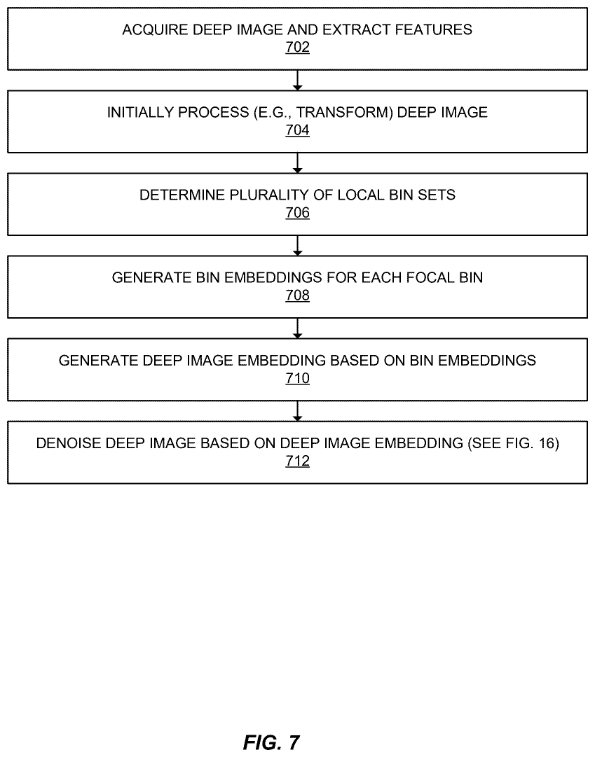

Having described some concepts related to deep images, machine learning, and denoising, it may be helpful to describe machine learning model and methods according to the present disclosure. As such, an overview of a machine learning model according to embodiments is presented below with reference to FIGS. 5 and 6. Machine learning models and methods according to embodiments are described in greater detail further below with reference to FIGS. 7, 12, 14, 15, 16, and 17.

FIG. 5 shows a machine learning model 502 comprising an embedding sub-model 504 (sometimes referred to as a “core network”) and a denoising sub-model 506 (sometimes referred to as “one or more reconstruction blocks”). In some embodiments, as described in more detail further below, the denoising model may comprise multiple reconstruction blocks, as different layers of the deep image (e.g., specular, diffuse, albedo, etc.) may be denoised independently based on the semantics of their contents. In general terms, the embedding sub-model 504 can take a noisy deep image input 508 as an input and produce a deep image embedding 510. The denoising sub-model 506 can use the deep image embedding 510 to denoise the noisy deep image, thereby producing a denoised deep image.

In slightly more detail, a noisy deep image input 508 (and/or per-bin features derived from the noisy deep image) can be provided to the embedding sub-model 504, which can extract information from the noisy deep image to produce a deep image embedding 510 (e.g., a latent space representation of the noisy deep image features) using local attention. The embedding sub-model 504 can produce the deep image embedding on a per-bin basis, e.g., for each bin in the deep image, the embedding sub-model 504 can generate a bin embedding and the deep image embedding 510 can comprise these bin embeddings. The noisy deep image input 508, along with the deep image embedding 510 can be provided to the denoising sub-model 506, which can produce a denoised deep image output 512. This denoised deep image output may comprise denoised layers, produced by one or more reconstruction blocks, which may be combined into the denoised deep image.

Some embodiments of the present disclosure can use a “multiscale” or “multi-resolution” approach to both generating deep image embeddings and denoising deep images based on deep image embeddings, and a high level summary of this multiscale approach is described below with reference to FIG. 6. The multiscale structure of machine learning model 602 of FIG. 6 has some similarities to the “U-net” structure sometimes found in convolutional neural networks.

The machine learning model 602, like machine learning model 502 of FIG. 5, can comprise an embedding sub-model 604 and a denoising sub-model 606. As in FIG. 5, the embedding sub-model 604 can be used to produce a deep image embedding 610 from a noisy deep image input 608, and the denoising sub-model 606 can be used to produce a denoised deep image output 612 based on the noisy deep image input 608 and the deep image embedding 610. However, in FIG. 6, the embedding sub-model 604 and denoising sub-model 606 can each comprise multiple “levels”, which may include a full-scale level (e.g., full-scale levels 614 and 622) and one or more downscale levels. More specifically, embedding sub-model 604 can comprise a full-scale level 614, a first downscale level 616, a second downscale level 618, and any number of further downscale levels (e.g., a third downscale level, a fourth downscale level) up to an n^{th} downscale level 620. Similarly, denoising sub-model 606 can comprise a full-scale level 622, a first downscale level 624, a second downscale level 626, and any number of further downscale levels up to an n^{th} downscale level 628. However, it should be understood that embedding sub-models and denoising sub-models according to embodiments can have any number of levels. In some cases, there may be a tradeoff between denoising quality and training and denoising time and memory complexity. A machine learning model according to embodiments with more levels may produce higher quality denoised images, but may take more time to train and denoise deep images and may require more memory.

In general terms, the embedding sub-model 604 can produce deep image embeddings corresponding to each level of the embedding sub-model 604. These embeddings can be combined to produce the deep image embedding 610. Likewise, the denoising sub-model 606 can generate a denoised deep image for each level of the denoising sub-model 606. These denoised deep images can be combined to produce the denoised deep image output 612. Generally, a deep image embedding produced by combining deep image embeddings from multiple levels may better extract and contain feature information from the noisy deep image input 608 (enabling more accurate denoising than a single level), and a denoised deep image produced by combining denoised deep images from multiple levels may have higher quality than a denoised deep image produced by a single level.

In slightly more detail, the embedding sub-model 604 can downscale the noisy deep image input 608 for each level of the embedding sub-model 604. For the full-scale level, the noisy deep image input 608 may not be downscaled at all, but may be progressively downscaled with each successive downscaling level. Downscaling is described in more detail further below, however in general terms, downscaling can involve removing bins from the deep image, e.g., either randomly or according to a pattern.

At each level, a deep image embedding (e.g., downscaled deep image embeddings 630-634, and full-scale deep image embedding 636) can be created using local attention transformers based on local regions of bins. In some embodiments, the size of each local region may increase with each successive downscaling layer, such that the quantity of bin data is generally constant even with downscaling. Afterwards, the deep image embeddings can be combined with deep image embeddings produced at lower downscale levels. The result of this combination can comprise the deep image embedding 610, which can be used by the denoising sub-model 606 to denoise the noisy deep image input 608 and produce the denoised deep image output 612.

Similarly, the denoising sub-model 606 can downscale the deep image embedding 610 for each of its downscaling levels, producing, e.g., downscaled deep image embeddings 638-642. At each level, the denoising sub-model 606 can produce a denoised deep image, e.g., downscaled denoised deep images 644-648 and full-scale denoised deep image 650. These denoised deep images can be combined to produce the denoised deep image output 612. In a denoising sub-model 606 comprising a plurality of reconstruction blocks, this process can be performed for each layer of the deep image (e.g., color, alpha, albedo, specular, diffuse, depth, etc.), thereby producing a plurality of denoised layers. The denoised deep image output 612 can comprise this plurality of denoised layers.

### V. EMBEDDING SUB-MODELS

Different embedding sub-model architecture and deep image denoising methods according to embodiments, e.g., implemented using such embedding sub-models, are described in more detail below with reference to FIGS. 7, 8, 12, 14, and 15, and with some additional reference to FIGS. 9, 10, 11, and 13A-13D. Such deep image denoising methods can be performed by a computer system, e.g., a computer system that instantiates, trains, and uses machine learnings models for the purpose of denoising deep images. As described above, such deep images can comprise arrays of pixels (or grid cells), and each pixel can correspond to zero or more bins. As such, deep images can comprise pluralities of bins.

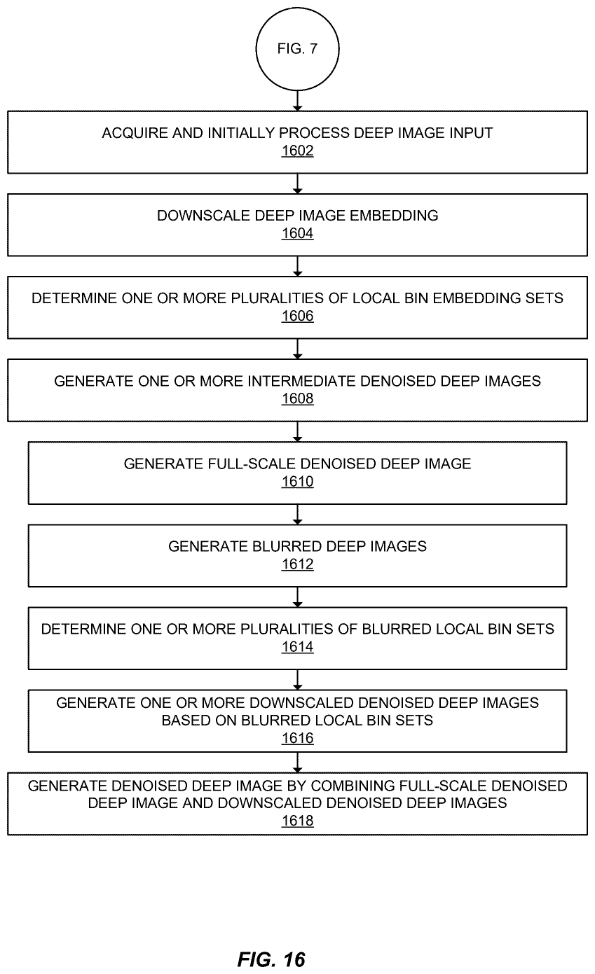

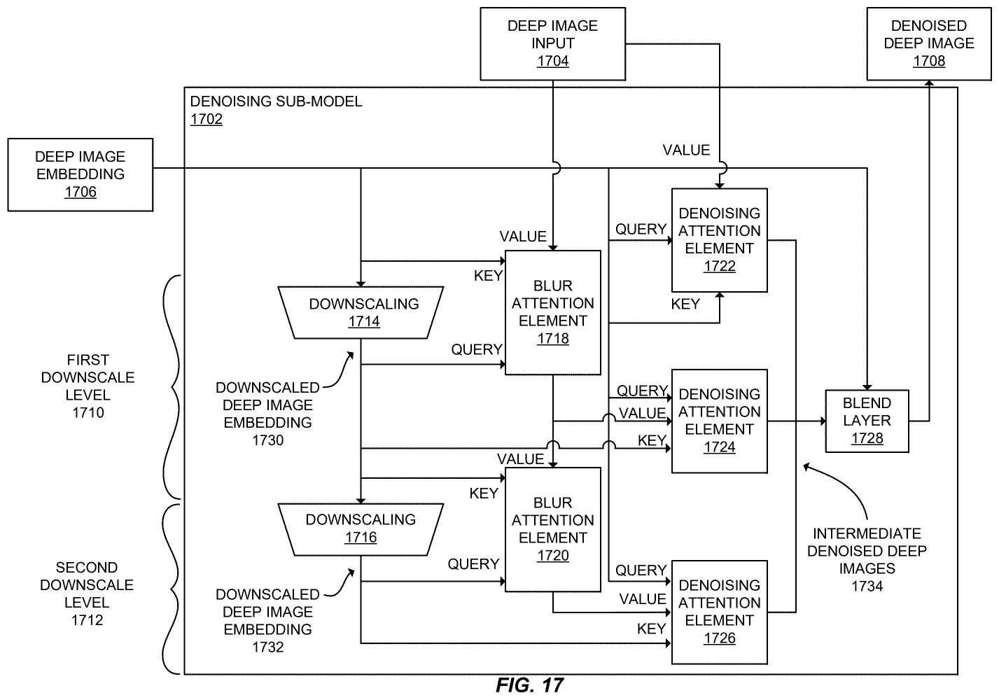

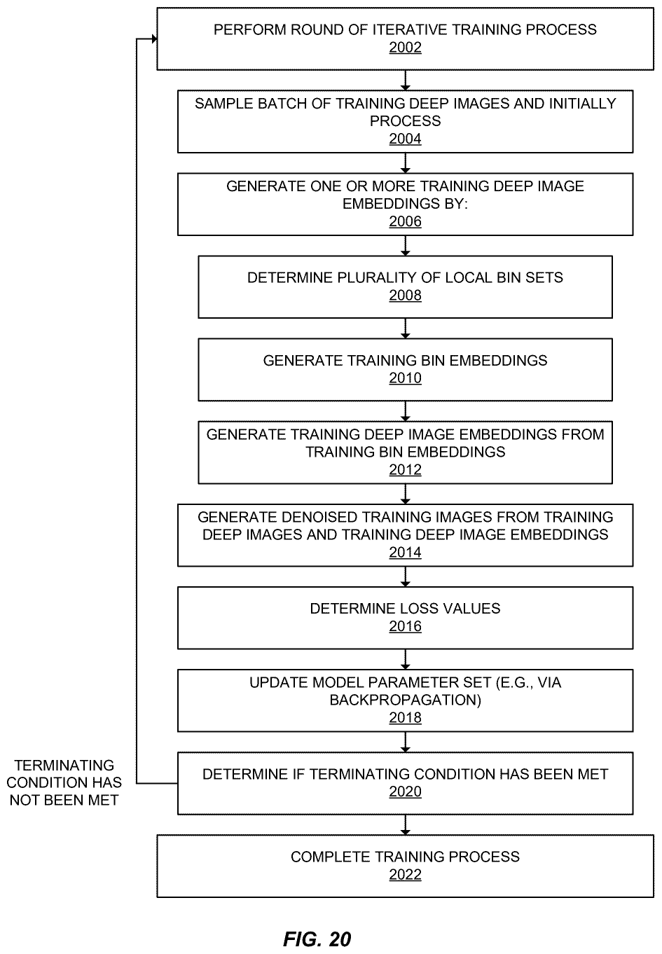

Generally, FIG. 7 depicts a flowchart of a deep image denoising method according to embodiments. The flowchart of FIG. 7 generally focuses on processes for generating a deep image embedding using an embedding sub-model. This deep image embedding can comprise per-bin features that can be used by the denoising sub-model in order to denoise a noisy deep image input. A single embedding sub-model can be used to generate a deep image embedding corresponding to a deep image with any number of layers, or in other words, an embedding sub-model can be shared between the layers of a noisy deep image input. More detail on processes for denoising deep images using the deep image embedding are described further below with reference to the denoising flowchart of FIG. 16 and the denoising sub-model of FIG. 17. Methods for training machine learning models according to embodiments are also described further below with reference to FIG. 20.

### A. Single Scale Embedding Sub-Model

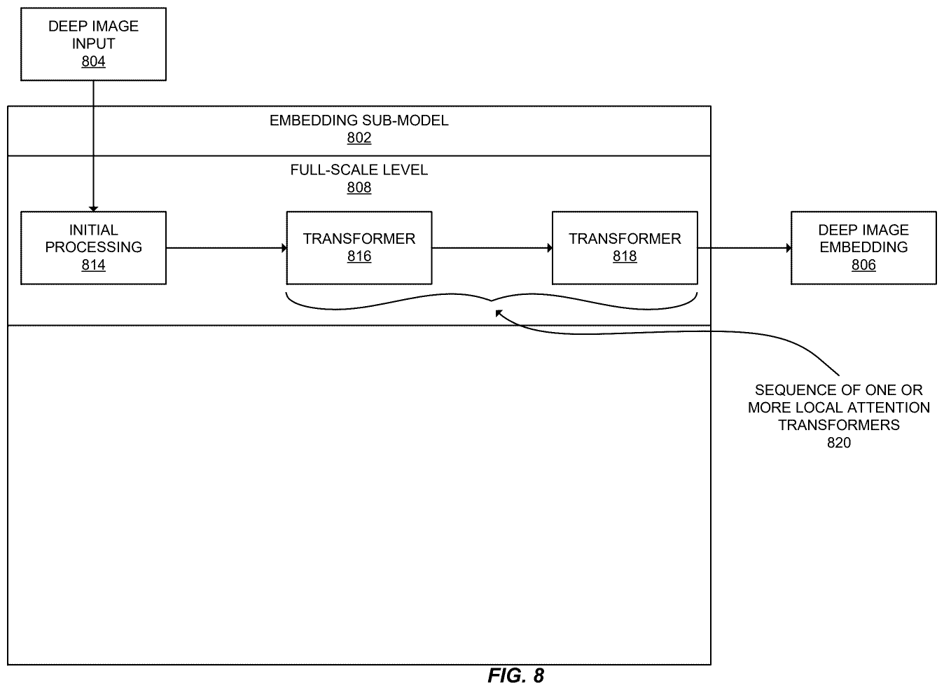

FIG. 8 shows a single scale embedding sub-model 802 comprising a full-scale level 808. As summarized above, a computer system can use embedding sub-model 802 to generate a deep image embedding 806 from a noisy deep image input 804. The embedding sub-model 802 can take noisy named per-bin features as inputs, e.g., color, alpha, depth, layer information, etc., from the deep image input 804 in order to produce the deep image embedding 806.

Referring to both FIGS. 7 and 8, at step 702 the computer system can acquire the deep image input 804 and extract relevant per-bin features. Such a deep image input 804 can comprise a plurality of pixels each corresponding to one or more bins. However, the deep image input 804 can comprise any number of additional pixels corresponding to zero bins, as it is not a requirement than every pixel in a deep image corresponds to a bin. There are various ways in which the computer system can acquire the deep image input 804. For example, the computer system could render the deep image input 804 itself using a rendering engine. Alternatively, the computer system could retrieve the deep image input 804 from a database or other data structure. As another alternative, the computer system could receive the deep image input 804 from a client computer. This could be the case if the computer system comprises a server computer that performs deep image denoising as a service for client computers. Such client computers could communicate with the computer system and transmit deep images to the computer system. The computer system could denoise these deep images for the client computers, then transmit the denoised deep images back to the client computers.

Such client computers may communicate with the computer system over a communications network. A communications network can take any suitable form, and may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between client computers and the computer system may be transmitted using a secure communications protocol, such as, but not limited to, File Transfer Protocol (FTP); HyperText Transfer Protocol (HTTP); Secure HyperText Transfer Protocol (HTTPS); Secure Socket Layer (SSL), ISO (e.g., ISO 8583) and/or the like. Any suitable communications protocol can be used to communicate over a communications network, e.g., for the purpose of creating one or more communication channels. A communications channel may, in some instances, comprise a secure communication channel, which may be established in any known manner, such as through the use of mutual authentication, a session key, and establishment of a Secure Socket Layer (SSL) session.

Regardless, after acquiring the deep image input 804, the computer system can extract various raw data from the deep image input 804. The deep image input 804 can contain named feature layers, which can include normal color data (including red, green, and blue color channels), depth data (if available), alpha data, albedo data, diffuse and specular layer data (which may also include color channels), etc. Each named feature layer can comprise a predetermined number of channels and can contain the per-bin data, as well as the bin layout of the layer. The computer system can extract this information using any appropriate means. For example, the computer system can parse or otherwise interpret an OpenEXR deep image file in order to extract per-bin features from the deep image input 804.

After acquiring the deep image features, at step 704, the computer system can perform initial processing operations on the deep image, e.g., by transforming the deep image features. In general terms, performing this initial processing can make it easier for the embedding sub-model 802 to generate the deep image embedding 806. The computer system can perform step 704 using initial processing block 814, which may comprise a configurable component used to transform input data (e.g., per-bin features) of various semantics into a common value range. In some embodiments, initial processing block 814 may comprise a non-trained component that transforms the extracted features, i.e., the input transformations performed using initial processing block 814 may not be learned during training. The exact fixed function input transformations used are customizable, and the example transformations presented below are intended to be non-limiting.

In some embodiments, the computer system initially processing the plurality of bins in the deep image input 804 by processing a plurality of “layer values” associated with the plurality of bins. Such layer values can comprise the extracted features from the deep image, e.g., color data values, diffuse and spectral layer values, etc. In some embodiments, the plurality of layer values can be processed by applying one or more operations to each layer value of the plurality of layer values. Non-limiting examples of such operations are described below.

As one example, the computer system can log transform layer values. For example, color values corresponding to color layers can be log transformed, e.g., by changing linear high dynamic range (HDR) colors into log colors. Diffuse and specular layer values can also be log transformed and clipped to a predetermined range (e.g., 0-6), as well as alpha-unpremultiplied and then log transformed and clipped to a predetermined range (e.g., 0-6). Some of these operations are described in more detail further below.

As indicated above, layer values can also be clipped to predetermined ranges. For example, alpha, albedo, diffuse, and specular layer values can be clipped to a predetermined range (e.g., 0-6), after log transforming those layer values, if applicable. Surface normal layer values (relating, e.g., to the orientation of a modeled surface at a ray hit location relative to a rendering camera viewpoint) can also be clipped to a predetermined range 0-1, e.g., after log transforming and/or alpha unpremultiplying those color layers

Also as indicated above, unpremultiplying is another operation that the computer system can apply to layer values. A deep image layer, such as a color layer or an albedo layer, may be in a premultiplied form. In premultiplied form, color channel data may be multiplied with alpha channel data. Unpremultiplying generally involves dividing out the alpha channel data from color channel data. Color corrections or other transformations can be applied to the unpremultiplied data, and afterwards the data can be “repremultiplied”.

As such, the initial processing can involve unpremultiplying and re-premultiplying the noisy deep image data with alpha. In some embodiments, albedo layer values can be alpha unpremultiplied e.g., prior to clipping those albedo layer values to a specific range (e.g., 0-6). Also, as stated above, diffuse and specular layer values can be alpha-unpremultiplied and then log transformed and clipped to a predetermined range (e.g., 0-6). Surface normal layer values can similarly be alpha-unpremultiplied and clipped to a range (e.g., 0-1).

As another example, the initial processing operations can include the computer system performing reciprocal operations on some layer values. Such reciprocal operations can involve replacing a layer value with its reciprocal, e.g., via a reciprocal transformation. In some embodiments, deep image depth layer values can be reciprocal transformed.

The initial processing operations can also include positionally encoding layer values. Positional encodings can be used to encode bin space positions and bin indices corresponding to bins in the noisy deep image input 804. There are various ways in which positional encodings can be generated, including sine encoding. As such, in some embodiments, the initial processing operations can include sine encoding layer values. Particularly, in some embodiments, depth layer values can be sine-encoded after being subject to a reciprocal transformation. Such positional encodings can be concatenated to other per-bin feature vectors generated during the initial processing, e.g., enabling the embedding sub-model to compare the positions of bins in the noisy deep image input 804. In general, sine encoding can be accomplished by generating sine and cosine waves between a chosen minimum and maximum wavelength. Such wavelengths can be chosen to be linearly spaced in log base 2 space. These wavelengths can be sampled at each position to be encoded in order to generate sine encodings.

Other initial processing operations include converting layer values to add-alpha formats and one-hot encoding layer values. As described above, alpha layer values can be clipped and converted to an add-alpha format. Additionally, layer values corresponding to metadata layers, such as frame identifier layer values and data source identifier layer values can be one-hot encoded.

As stated above, various input transformations can be performed and the examples provided above are intended to be non-limiting. Additionally, the embedding sub-model can also accept various attentional features derived from the deep image in addition to the transformed features from the noisy deep image input.

After the input features are transformed, the computer system can transform the dimensions of the noisy deep image input tensor to facilitate processing by subsequent elements of the embedding sub-model 802 (e.g., the sequence of one or more local attention transformers 820) to produce the deep image embedding 806. Prior to this transformation, the noisy deep image input tensor can comprise a Batch (N)×Height (H)×Width (W)×Bin (B)×Channel (C) tensor, in which the bin dimension is ragged and all other dimensions have a fixed value. After the transformation, the noisy deep image input tensor can comprise a Total_Bins×Channel (C) tensor.

Such a Total_Bins×Channel (C) tensor can be represented using “row split layouts”, and an exemplary row split layout with numerical values is shown in FIG. 9, which shows a one dimensional array of values 902 and a one dimensional array of row splits 904. A tensor 906 can be defined by these two arrays. The values 902 can comprise the values stored in the tensor 906, while the row splits 904 can effectively define the number of values associated in each element (e.g., row) of the tensor 906. In a deep image, the values 902 can comprise per-bin features (e.g., layer values, transformed in the ways described above). The row splits 904 can define the number of bins (or bin features) associated with each pixel location, e.g., by defining the indices of the first bin or feature (from values 902) associated with each pixel location.

In addition, the compute system can generate a bin layout tensor comprising a cumulative sum of the bin counts of each pixel in the deep image. This representation allows efficient access to any bin given its position in two memory reads, one to the bin layout tensor and an indirect read to the data tensor. This improves the speed at which the embedding sub-model can be trained and used to generate deep image embeddings.

Referring back to FIGS. 7 and 8, the input transformations of initial processing block 814 can maintain the bin layout of the noisy deep image input 804. As a result, the deep image embedding 806 can have the same layout of the noisy deep image input 804. This may be useful during denoising, as direct correspondence between bins in the deep image input and bin embeddings in the deep image embedding may enable denoising based on local cross-attention between bins and bin embeddings.

After acquiring the deep image input 804 and performing initial processing operations using initial processing block 814, the computer system can generate a deep image embedding using the embedding sub-model 802. To this end, at step 706, the computer system can determine a plurality of local bin sets corresponding to the plurality of bins. Each local bin set can comprise a plurality of local bins from the plurality of bins and a respective focal bin. Each plurality of local bin sets can correspond to a local region, e.g., each plurality of local bin sets can comprise the bins within a local region. Various examples of local regions were described above with reference to FIGS. 3 and 4A-4D. In some embodiments, each plurality of local bins can be within a specified distance of a respective focal bin. In the case of a circular local region, a specified distance could comprise a specified radius, such that the circular local region is centered on a focal bin and contains bins within a circle, sphere, or hypersphere defined by that specified radius. As another example, each plurality of local bins can be within a conic region, e.g., defined by a circle projected into three dimensions from a rendering camera viewpoint (or camera transformation). Such a conic region can capture an increasingly large cross-sectional area of bins at increasing distance from the rendering camera position.

Summarized generally, for each bin (e.g., each focal bin for a corresponding local region) in the ragged deep image tensor, the computer system can identify all the bins within the specified distance of that bin, and a corresponding local bin set can comprise the focal bin and those identified bins. In some embodiments, the computer system can identify bins within a specified distance of each focal bin using positional encodings. In some implementations, e.g., in which the computer system comprises a distributed computing system or a multicore computing system, the computer system can identify the plurality of local bin sets in parallel (e.g., concurrently).

At step 708, the computer system can generate a bin embedding for each focal bin (i.e., each bin) in the deep image. The computer system can generate the bin embeddings based on attention of a corresponding local bin set. In this way, the computer system can generate a plurality of bin embeddings corresponding to the plurality of bins in the deep image, e.g., one bin embedding per bin in the deep image. The computer system can generate these bin embeddings using local attention transformers, such as local attention transformers 816 and 818. Such local attention transformers can be arranged in a sequence of one or more local attention transformers 820, e.g., such that the output of each local attention transformer comprises the input of the subsequence local attention transformer. Although only two local attention transformers 816 and 818 are depicted in FIG. 8, it should be understood that the sequence of one or more local attention transformers 820 can comprise any number of local attention transformers.

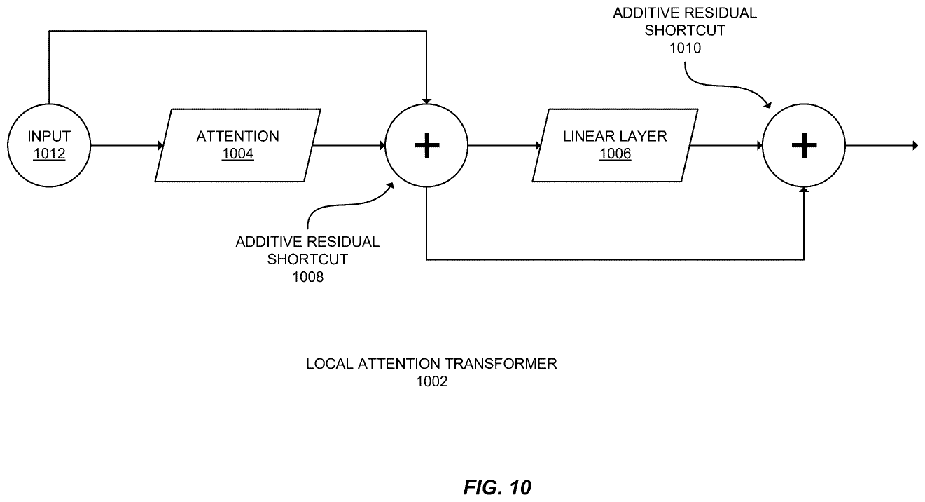

Local attention transformers according to embodiments may be better understood with reference to local attention transformer 1002 of FIG. 10. In embodiments of the present disclosure, the input 1012 to the local attention transformer 1002 can comprise a single set of per-bin embeddings corresponding to a local bin set, e.g., generated via the initial processing of step 704 and determined via step 706 of FIG. 7. These inputs can be transformed into one set of query, key, and value tensors per attention head. Some embodiments of the present disclosure use multi-head attention with four attention heads. However, it should be understood that other numbers of attention heads can be used.

This input 1012 can be applied to attention layer 1004, which can perform the local attention operation. An additive residual shortcut 1008 can add the output of the attention layer 1004 and the input features together. The output of the additive residual shortcut 1008 can be applied to linear layer 1006 (which can comprise a dense or fully connected layer), which can be implemented via matrix multiplication, and the output of additive residual shortcut 1008 can be combined with the output of the linear layer 1006 via additive residual shortcut 1010. This combination can comprise the output of the local attention transformer 1002. In some embodiments, the local attention transformer 1002 may not include normalization layers commonly seen in other transformers.

As described above, one distinction between a local attention layer such as local attention layer 1004 and a regular attention layer is which inputs can attend to one another. In a local attention layer according to embodiments, bins can attend to other bins within the same local region and local bin set. This enforces locality of computation and reduces computation cost. By contrast, in a conventional transformer, e.g., used in a large language model, each token (input) can attend to any other token in the same sequence for self-attention. As described above, this is not practical for denoising deep images with large numbers of per-bin embeddings, as attention is quadratic with respect to the number of tokens.

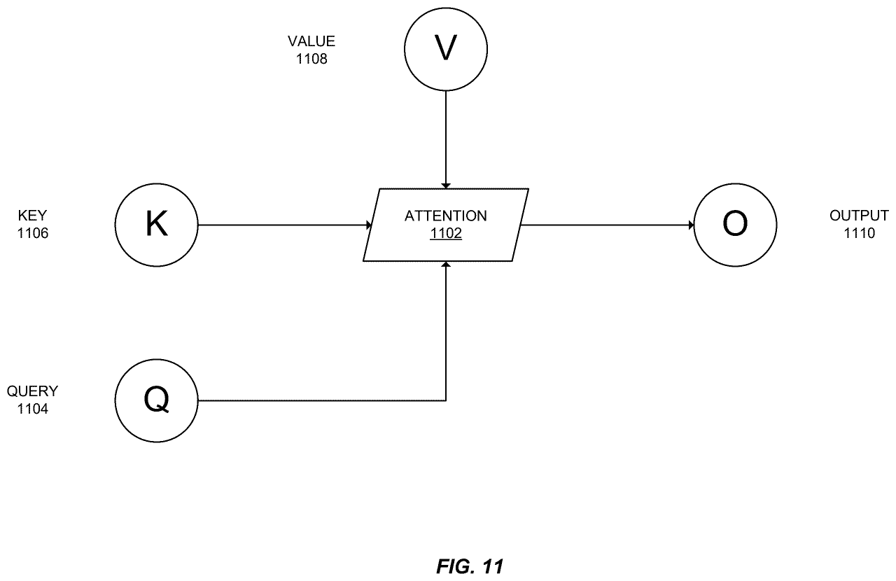

The local attention layer 1004 can be better understood with reference to FIG. 11, which shows a local attention layer 1102. Local attention according to embodiments can be implemented with a dot-product between query embeddings 1104 (after an optional linear layer) of a focal bin and key embeddings 1106 (also after an optional linear layer) of all bins within the local bin set, including the focal bin. The result of this operation can be processed with a per-center-bin softmax, which can give a weight to each local bin with respect to the focal bin, summing up to 1. The weights can be multiplied with the value 1108 associated which each local bin (again after an optional linear layer) and summed up. This can comprise the per-bin output 1110 of local attention operation. The optional linear layers can derive the query 1104, key 1106, and/or value 1108 embedding from a primary bin embedding. In some embodiments, these optional linear layers can comprise the second largest source of trainable weights in some machine learning models according to embodiments.

Notably, the attention layer 1102 can be used to implement both self-attention and cross-attention, and in some cases, implement forms of attention that may be difficult to categorize as either self-attention or cross-attention. On one hand, some local attention transformers used in embedding sub-models according to embodiments apply attention to a single set of inputs, i.e., the bins in a local bin set, which suggests a form of self-attention with masking base on local regions. On the other hand, the attention is computed based on the attention between the focal bin and the bins in the local region, which could be considered a form of cross-attention between two sets, one comprising the focal bin and the other comprising the bins in the local region. Hence, it should be understood that embedding sub-models according to embodiments of the present disclosure can be practiced using both self-attention and cross-attention.

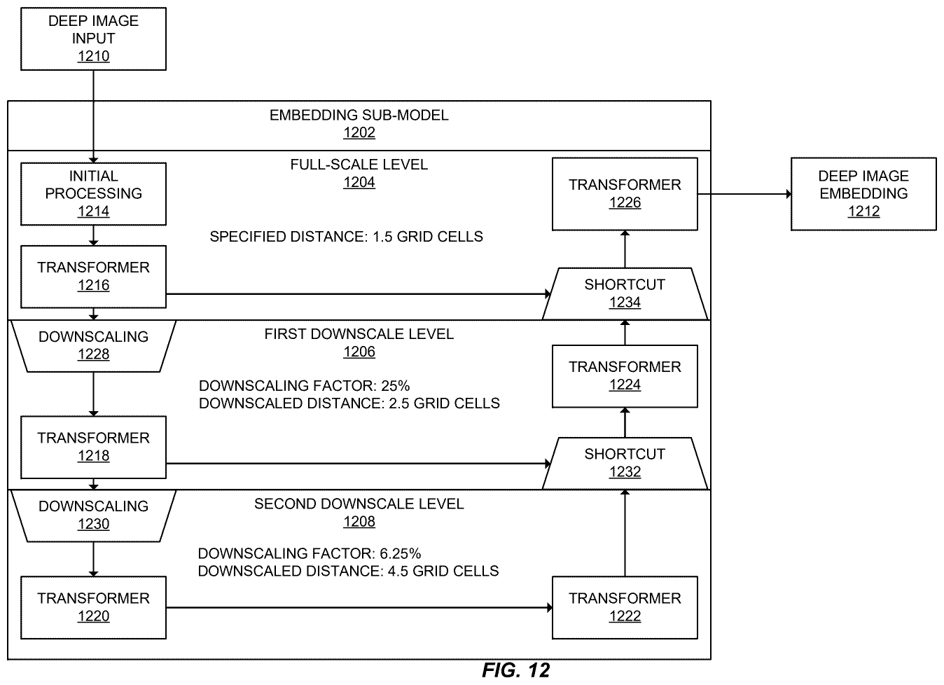

Referring back to FIGS. 7 and 8, at step 710, the computer system can generate the deep image embedding 806 based on the plurality of bin embeddings. In some embodiments, the deep image embedding can comprise the plurality of bin embeddings. As such, generating the deep image embedding can comprise grouping the plurality of bin embeddings into a single deep image embedding 806. However, in multiscale embedding sub-models (e.g., as depicted in FIGS. 12, 14, and 15 and described further below), the deep image embedding can be generated from pluralities of bin embeddings generated from multiple embedding sub-model levels. In such cases, the computer system can use different methods to generate the deep image embedding based on one or more pluralities of bin embeddings.

At step 712, the computer system can use the denoising sub-model to generate a denoised deep image. In general terms, the computer system can generate the plurality of denoised bins by applying the denoising sub-model to the plurality of bins of the deep image and the deep image embedding to produce the plurality of denoised bins. The denoised deep image can comprise the plurality of denoised bins. This process is described in more detail further below with reference to FIGS. 16 and 17.

### B. Multiscale Network Embedding Sub-Model

As described above, embedding sub-models according to embodiments can comprise both single scale embedding sub-models and multiscale embedding sub-models. FIG. 1202 shows a multiscale embedding sub-model 1202 according to embodiments. Methods for generating deep image embeddings using multiscale embedding sub-models are similar to methods for generating deep image embeddings using single scale embedding sub-models, with some differences. For example, a computer system can acquire a deep image input 1210 and perform initial processing operations on the deep image input 1210. The computer system can then use the embedding sub-model 1202 to generate a deep image embedding 1212, e.g., via a sequence of local attention transformers (e.g., local attention transformers 1216-1226). Such local attention transformers 1216-1226 can be similar to the local attention transformers described above with reference to FIG. 10, and may comprise local attention layers similar to those described above with reference to FIG. 11. Thus, local attention transformers 1216-1226 can be understood with reference to those figures and the description above. Likewise, methods for generating deep images using multiscale sub-models can generally be understood with reference to the description of the flowchart of FIG. 7 above. The description below primarily focuses on differences in model architecture and differences between multiscale and single scale methods for generating deep image embeddings.

As depicted in FIG. 12, embedding sub-model 1202 comprises a full-scale level 1204, a first downscale level 1206, and a second downscale level 1208. It should be understood however that multiscale embedding sub-models according to embodiments can comprise any number of levels, and that embedding sub-model 1202 is intended only as one non-limiting example. Generally, more levels may result in higher quality denoised deep images, but increases the number of trainable parameters, which may increase the time it takes to train embedding sub-model 1202 and use embedding sub-model 1202 to generate deep image embeddings. The arrangement of embedding sub-model components (e.g., local attention transformers 1216-1226) in embedding sub-model 1202 is somewhat similar to the “u-net” architecture found in some convolutional neural networks.

As described above with reference to the single scale embedding sub-model of FIG. 8 and the embedding flowchart of FIG. 7, in some embodiments a computer system can determine a plurality of local bin sets corresponding to the plurality of bins, which can each contain a plurality of local bins from a plurality of bins in the deep image and a respective focal bin. As the embedding sub-model 802 of FIG. 8 comprises a single (full) scale embedding sub-model, this plurality of local bin sets can comprise a plurality of full-scale local bin sets, and the plurality of bin embeddings generated from the plurality of local bin sets (e.g., at step 708) can comprise a plurality of full-scale bin embeddings. As described above, the computer system can generate each full-scale bin embedding of the plurality of full-scale bin embeddings using a local attention transformer (or, e.g., a sequence of one or more local attention transformers) based on attention of a corresponding full-scale local bin set. In this way the computer system can generate the plurality of full-scale bin embeddings. A deep image embedding can be generated based on this plurality of full-scale bin embeddings.

Likewise, a computer system can use a multiscale embedding sub-model such as embedding sub-model 1202 to generate a plurality of full-scale bin embeddings using local attention transformers, e.g., local attention transformer 1216. However, the computer system can also generate one or more pluralities of downscaled bin embeddings. Such downscaled bin embeddings can correspond to one or more downscaling levels, e.g., the first downscaling level 1206 and the second downscaling level 1208. Further, instead of generating a deep image embedding 1212 based on the full-scale bin embeddings alone, the computer system can use the embedding sub-model 1202 to generate a deep image embedding using the one or more pluralities of downscaled bin embeddings in addition to the plurality of full-scale bin embeddings.

Generally, after initially processing a noisy deep image input 1210 (e.g., using initial processing block 1214 of embedding sub-model 1202) and generating a plurality of full-scale bin embeddings (e.g., using local attention transformer 1216), a computer system can perform one or more downscaling operations on the plurality of full-scale bin embeddings. In this way, the computer system can generated one or more pluralities of initial downscaled bin embeddings. Generally, these downscaling operations can be performed via elements on the left side of embedding sub-model 1202, i.e., downscaling layers 1228 and 1230 and local attention transformer 1218. Later, these initial downscaled bin embeddings can be used to produce one or more pluralities of downscaled bin embeddings. The one or more pluralities of downscaled bin embeddings can be combined with the plurality of full-scale bin embeddings to produce the deep image embedding. Generally, this combination can be achieved via elements on the right side of the embedding sub-model 1202, e.g., shortcut layers 1232 and 1234 and local attention transformers 1224 and 1226.

In more detail, downscaling layers 1228 and 1230 of FIG. 12 can implement configurable downscaling, e.g., via dropout. The downscaling layers 1228 and 1230 can reduce the bin embedding density in the plurality of full-scale bin embeddings, and can fulfill a similar role as max-pooling or average pooling. By using dropout instead of these pooling operations, bin embedding becomes more sparse, but the logical size of the bin embeddings is not changed. In some embodiments, the downscaling layers can implement dropout using fixed functions, which may not be trained and which may not include trainable parameters. By performing dropout via downscaling layer 1228, the computer system can remove one or more bin embeddings from the plurality of full-scale bin embeddings.

Downscaling operations implemented via dropout can correspond to “downscaling factors” “scale factors” or “keep rates”. Generally, the number of removed bin embeddings can be proportional to the one or more downscaling factors. As a general example, 25% of bins are kept during dropout for a downscaling factor, scale factor, or keep rate of 25%, while the remaining 75% of bins are dropped. Each level of embedding sub-model 1202 can correspond to a different downscaling factor of one or more downscaling factors. The multiscale network of embedding sub-model 1202 can thereby correspond to these one or more downscale factors. The full-scale level 1204 can correspond to a (full) scale factor of 100%, the first downscale level 1206 can correspond to a downscaling factor of 25% (a “quarter scale factor”) and the second downscale level 1208 can correspond to a downscaling factor of 6.25% (a “sixteenth scale factor”). Generally, this means that roughly 75% of bins are dropped between the full-scale level 1204 and the first downscale level 1206, and 93.75% of bins are dropped between the full-scale level 1204 and the second downscale level 1208. In other words, of the 25% of bins that are kept by downscaling layer 1228, 75% of those are dropped by downscaling layer 1230. It should be understood that these downscaling factors are provided for the purpose of example, and that methods according to embodiments can be practiced using any appropriate downscaling factors.

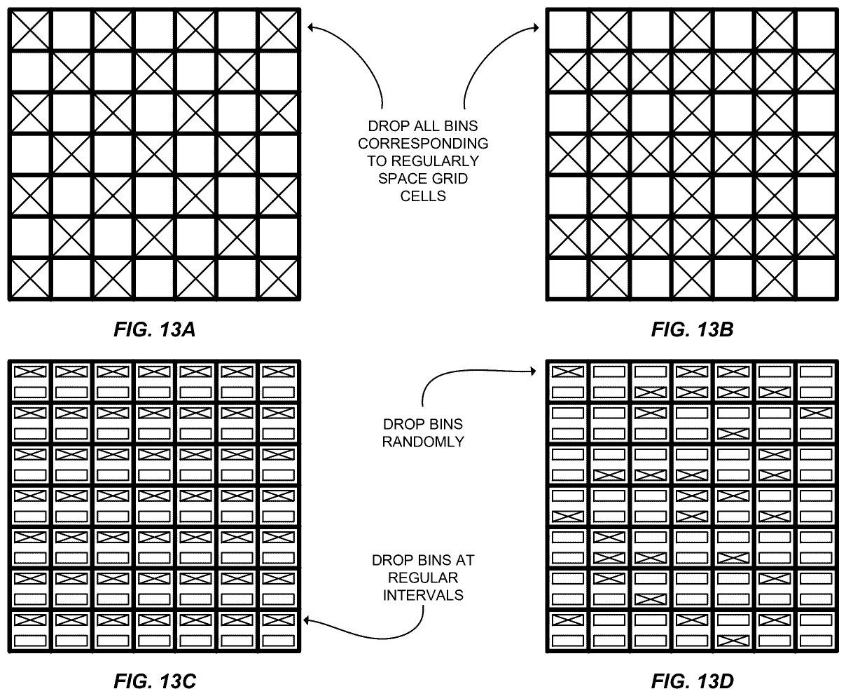

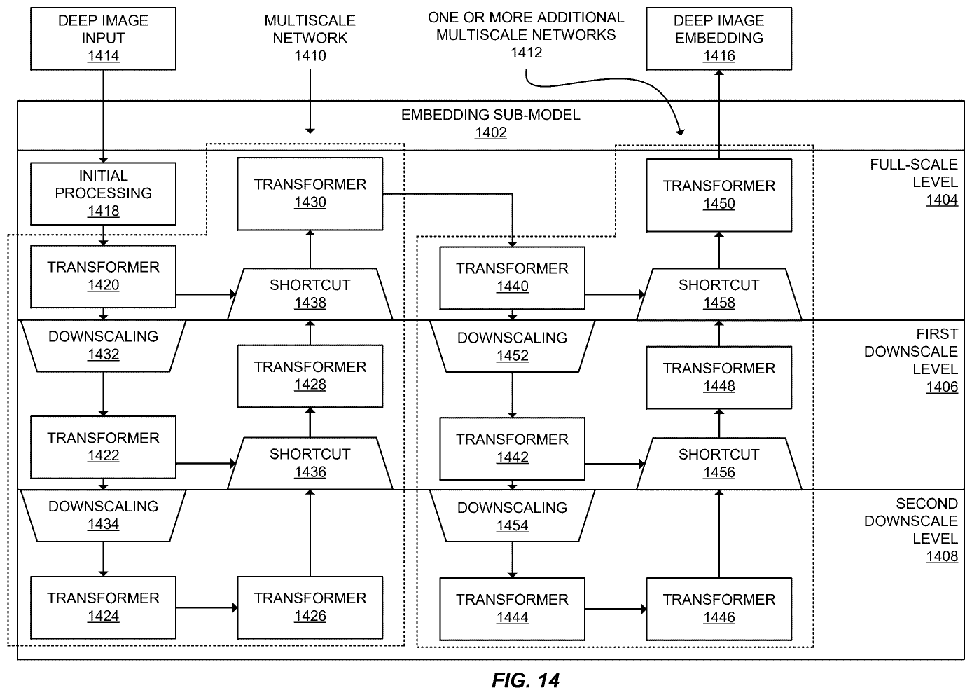

Dropout methods according to embodiments may be better understood with reference to FIGS. 13A-14B. In some embodiments, the computer system can downscale the plurality of full-scale bin embedding by performing random or regular pattern per-pixel bin dropout. Alternatively, downscaling the plurality of full-scale bin embeddings can comprise random or regular pattern bin dropout. In general, in regular pattern bin dropout, every n^{th} bin can be kept based on a keep rate (or downscaling factor). For example, for a keep rate of 6.25%, every 16th bin can be kept, while the remaining bins are dropped. Regular pattern bin dropout is illustrated in FIG. 13C, which shows a grid in which each grid cell (e.g., pixel) comprises two bins. In FIG. 9, the keep rate is 50%, and every other bin is dropped (as indicated by the “X's”). In random pattern bin dropout, every bin has a probability to be kept or dropped based on the keep rate. For example, for a keep rate of 25%, every bin has a 25% chance of being kept. FIG. 13D shows the application of random bin dropout with an unspecified keep rate to a deep image.

By contrast, in per-pixel dropout, all bins corresponding to particular pixels are dropped. Generally, testing has shown that high quality deep image denoising can be achieved with regular per-pixel dropout patterns. In a regular pattern per-pixel dropout, all bins corresponding to regularly arranged pixels can be dropped. Regular pattern per-pixel dropout is illustrated by FIGS. 13A and 13B. In FIG. 13A, the keep rate is 50%, such that all bins corresponding to every other pixel (grid cell) are dropped. In FIG. 13B, the keep rate is 25%, such that bins corresponding to every three out of four pixels are dropped. However, unlike FIG. 13A, in 13B pixels are dropped based on small two by two regions, such that the “upper left” pixel of each two by two region is kept and bins corresponding to the remaining three pixels are dropped. In contrast to per-pixel regular dropout, in per-pixel random dropout, all bins corresponding to randomly selected pixels (e.g., according to a defined keep rate) can be dropped.

As described above, there are other ways in which downscaling can be implemented in methods according to embodiments, e.g., via max and mean pooling. As such, dropout is intended to be a non-limiting example a downscaling technique that can be used in methods according to embodiments. In addition, methods according to embodiments can be practiced with other dropout techniques, including low-discrepancy or stratified random pattern dropout. As such, the dropout patterns described above are non-limiting examples.

Referring back to FIG. 12, as described above, to generate the plurality of full-scale bin embeddings, the computer system can determine one or more pluralities of full-scale local bin sets and generate the plurality of full-scale bin embeddings using a local attention transformer (e.g., local attention transformer 1216). Likewise, to generate one or more pluralities of downscaled bin embeddings, the computer system may determine one or more pluralities of initial downscaled local bin embedding sets. Each plurality of local bin embedding sets may correspond to a downscale level of embedding sub-model 1202. For example, a first plurality of local bin embedding sets may correspond to the first downscale level 1206, while a second plurality of local bin embedding sets may correspond to the second downscale level 1208. Each plurality of initial downscaled local bin embedding sets can be determined from a corresponding plurality of initial downscaled bin embeddings, e.g., produced via downscaling layers 1228 and 1230 and the downscaling operations described above. Such downscaling operations may be “stepwise”, e.g., a computer system can downscale the plurality of full-scale local bin embeddings to the first downscale level, thereby generating a plurality of downscaled local bin embeddings. This plurality of downscaled local bin embeddings can be subsequently downscaled to the second downscale level 1208, thereby generating another plurality of downscaled local bin embeddings. As such, the one or more pluralities of initial downscaled local bin embedding sets can correspond to the one or more downscaling factors. In some embodiments, the one or more pluralities of initial downscaled local bin embedding sets can comprise a plurality of quarter-scale local bin embedding sets (corresponding to a quarter-scale factor and comprising quarter-scale local bin embeddings) and a plurality of sixteenth-scale local bin embedding sets (corresponding to a sixteenth-scale factor and comprising sixteenth scale local bin embeddings).

Each initial downscaled local bin embedding set can comprise a plurality of initial downscaled local bin embeddings and a respective initial downscaled focal bin embedding. Each plurality of initial downscaled local bin embeddings can be within a specific downscaled distance of the respective initial downscaled focal bin embedding. FIG. 12 shows exemplary downscaled distances associated with the first downscale level 1206 (i.e., 2.5 grid cells) and an exemplary downscaled distance associated with the second downscale level 1208 (i.e., 4.5 grid cells). However, it should be understood that these downscaled distances are exemplary, are intended to be non-limiting, and that methods according to embodiments can be practiced with different downscaled distances.

For the downscaled distances of FIG. 12, a plurality of initial downscaled local bin embedding sets corresponding to the first downscale level 1206 could comprise initial downscaled local bin embedding sets for which bin embeddings are within 2.5 grid cells (pixels) of their respective focal bin embeddings. Likewise, a plurality of initial downscaled local bin embedding sets corresponding to the second downscale level 1208 could comprise initial downscaled local bin embedding sets for which bin embeddings are with 4.5 grid cells of their respective focal bin embeddings. In some embodiments the downscale distances can comprise radiuses defining circular local regions. The computer system can evaluate such distances via positional encodings generated during initial processing or using any other appropriate process.

Generally, while the number of bin embeddings decreases in each successive downscaling layer due to dropout, the downscaling distances (and therefore the size of local regions used for local attention) can increase in successive layers (e.g., from 1.5 to 2.5 to 4.5). As a result, the total size of each downscaled local bin embedding set is generally constant. As such, the use of multiple scales generally enables the embedding sub-model to benefit from larger local attention regions without bearing the cost of quadratic scaling with respect to the area of those regions.

After determining the one or more pluralities of initial local bin embedding sets (e.g., a first plurality of initial local bin embedding sets corresponding to first downscale level 1206 and a second plurality of initial local bin embedding sets corresponding to second downscale level 1208), the computer system can use the embedding sub-model 1202 to generate a downscaled bin embedding for each initial downscaled focal bin embedding. The computer system can generate these downscaled bin embeddings based on attention of a corresponding initial downscaled local bin embedding set. In this way, the computer system can generate one or more pluralities of downscaled bin embeddings. These one or more pluralities of downscaled bin embeddings can correspond to one or more downscaling factors and one or more downscaling levels. For example, a first plurality of downscaled bin embeddings can correspond to the first downscale level 1206 and a second plurality of downscaled bin embeddings can correspond to the second downscale level 1208. The computer system can use local attention transformers to generate these downscaled local bin embeddings, e.g., similar to as described above with reference to FIGS. 7, 8, 10, and 11. For example, the computer system can use local attention transformers 1218 and 1224 (in addition to shortcut block 1232, described in more detail further below) to generate a first plurality of downscaled bin embeddings, and can use local attention transformers 1220 and 1222 to generate a second plurality of downscaled bin embeddings.

After generating one or more pluralities of downscaled bin embeddings, the computer system can generate deep image embedding 1212 based on the one or more pluralities of downscaled bin embeddings in addition to the plurality of bin embeddings, e.g., by combining the one or more pluralities of downscaled bin embeddings and the plurality of full-scale bin embeddings. As a result of this combination, deep image embedding 1212 may contain additional feature information, which may enable a denoising sub-model to produce a higher quality denoised deep image. The computer system can combine the one or more pluralities of downscaled bin embeddings and the plurality of bin embeddings using a sub-network of the multiscale network. In FIG. 12, such a sub-network could comprise the elements on the right side of embedding sub-model 1202, e.g., the shortcut blocks 1232 and 1234 and local attention transformers 1224 and 1226.

Generally, a shortcut block can be used to combine the bin embeddings from a given level with the bin embeddings from a lower level. For example, shortcut block 1232 can combine a plurality of downscaled bin embeddings associated with the first downscale level 1206 with a plurality of downscaled bin embeddings associated with the second downscale level. The shortcut blocks 1232 and 1234 can up-scatter (merge) bin embeddings from lower scales into the shape of upper scales, resulting in tensors with the same bin layout of the upper scale.

There are various possible implementations of shortcut blocks 1232 and 1234. As one example, the shortcut blocks 1232 and 1234 can perform upscattering then combine bin embeddings via addition, e.g., adding the bin embedding values from a lower scale to corresponding bin embeddings of a higher scale. As another example, the shortcut blocks 1232 and 1234 can perform upscattering, then concatenate the bin embeddings from the lower scale with bin embeddings from the upper scale in a feature dimension. The concatenated bin embeddings from the two scales can be merged via a linear layer (e.g., a neural network). Once the one or more pluralities of downscaled bin embeddings and the plurality of full-scale bin embeddings are combined, the computer system can use local attention transformer 1226 and the combined bin embeddings to produce an intermediate deep image embedding, which may comprise the deep image embedding 1212, or which may be used to derive the deep image embedding 1212.

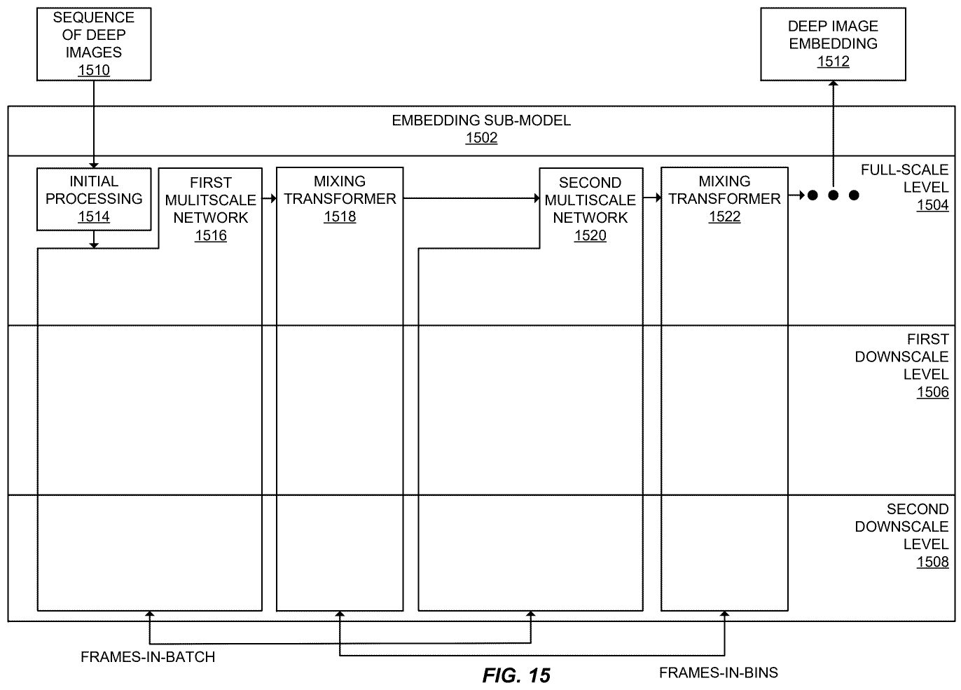

It should be understood that methods according to embodiments can be practiced with other multiscale embedding sub-model architecture. For example, shortcut blocks could be used on both the left and right sides of the multiscale network. Another alternative is to use transformers on each scale in parallel instead of in series. It should be understood that the examples of multiscale embedding sub-models described herein are intended only as non-limiting examples. Some other multiscale embedding sub-model variants are described below with reference to FIGS. 14 and 15.

### C. Sequential Multiscale Network Embedding Sub-Model

As depicted in FIG. 14, in some embodiments, an embedding sub-model 1402 can comprise a multiscale network 1410 and one or more additional multiscale networks 1412. While only one additional multiscale network 1412 is shown in FIG. 14, it should be understood that machine learning models according to embodiments can comprise any number of additional multiscale networks. These multiscale networks can generally comprise the same components (e.g., local attention transformers, downscaling blocks, shortcut blocks, etc.) as the multiscale network of FIG. 12, and can generally be understood with reference to the description above. For example, multiscale network 1410 may comprise local attention transformers 1420-1430, downscaling layers 1432 and 1434, and shortcut blocks 1436 and 1438. Likewise, additional multiscale network 1412 can comprise local attention transformers 1440-1450, downscaling layers 1452 and 1454, and shortcut blocks 1456 and 1458.

Generally and as described above with reference to FIG. 12, after initially processing a noisy deep image input 1210 (e.g., via initial processing block 1214), a computer system can use the multiscale network of embedding sub-model 1202 to generate a deep image embedding 1212, which may comprise the output of the embedding sub-model. A computer system can use the embedding sub-model 1402 of FIG. 14 in a similar way. However, unlike the embedding sub-model 1202 of FIG. 12, the multiscale network 1410 and the one or more additional multiscale networks 1412 can be arranged in a sequence of multiscale networks, such that an output of each multiscale network or additional multiscale network comprises an input to a subsequent additional multiscale network or comprises an output of the sequence of multiscale networks. As such, the bin embeddings produced as the output of multiscale network 1410 (which may be referred to as an “intermediate deep image embedding”) can be applied to the one or more additional multiscale networks 1412, the output of which can comprise the deep image embedding 1416, i.e., the output of the sequence of multiscale networks.

There are several advantage to the sequential multiscale network configuration of FIG. 14 over the single multiscale network of FIG. 12. For example, each multiscale network can have a different downscaling dropout pattern, e.g., by offsetting grid cells (pixels) or varying a random seed. This allows the network to have more variety in the far reaching lower scales, which may result in higher quality deep image embeddings (which may further result in higher quality denoised deep images). However, adding one or more additional multiscale networks to an embedding sub-model may increase the number of model parameters, and may thereby increase training time and execution time.

D. Sequential Multiscale Network Embedding Sub-Model with Temporal Denoising

One advantage of the sequential multiscale embedding sub-model of FIG. 14 is that it can be modified to implement temporal denoising on sequences of noisy deep images (e.g., those that are part of a frame sequence of animation) by including temporal mixing transformers between successive multiscale networks. FIG. 15 shows an embedding sub-model 1502 that includes mixing transformers 1518 and 1522, in addition to a first multiscale network 1516 and a second multiscale network 1520. It should be understood that embedding sub-models according to embodiments can have any number of multiscale networks and mixing transformers and that the number of multiscale networks and mixing transformers depicted in FIG. 15 is intended only as a non-limiting example.

Rather than receiving a single deep image as an input, embedding sub-model 1502 can receive a sequence of deep images 1510. The sequence of deep images 1510 can comprise a “focal deep image” (also referred to as a “focal frame”) and one or more additional deep images (one or more other frames). A sequence of deep images 1510 can comprise any number of deep images. As stated above, such a sequence of deep images 1510 could comprise a sequence of frames of animation, e.g., for an animated feature film. In some embodiments, the focal deep image may comprise a “center deep image” in the sequence of deep images 1510. For example, in a sequence of five deep images, the focal deep image may comprise the third deep image, such that there are two deep images prior to the focal deep image and two deep images after the focal deep image. In some embodiments each deep image in the sequence of deep images 1510 can be indexed by an offset relative to a center frame. For example, in a seven frame sequence of deep images, offsets could comprise the numbers {−3, −2, −1, 0, 1, 2, 3}, in which the center frame has offset zero.

As described above with reference to FIGS. 7, 8, 12 and 14, a computer system can use an embedding sub-model to generate a deep image embedding, which can comprise latent space features extracted from deep image input. Such latent space features can be used by a denoising sub-model in order to denoise the deep image. Likewise, a computer system can use embedding sub-model 1502 to generate a deep image embedding 1512 corresponding to the focal deep image from the sequence of deep images. The computer system can also use mixing transformers 1518 and 1522 to embed latent space features corresponding to one or more other deep images (in the sequence of deep images) in deep image embedding 1512. These latent space features can enable the computer system to use a denoising sub-model to temporally denoise the focal deep image temporally in addition to spatially. The mixing transformers 1518 and 1522 can comprise attention based transformers, which may not use local attention. Instead, attention may be computed between each bin in the focal deep image and corresponding bins in the one or more other deep images. In some embodiments, these attention operations can be performed in parallel.

In order to enable temporal mixing by mixing transformers 1518 and 1522, the bins in deep images in the sequence of deep images 1510 many need to be aligned with the bins in the focal deep image. This can be accomplished by warping, which can be performed using initial processing block 1514 or in a pre-processing stage, e.g., outside of embedding sub-model 1502. Generally, warping can involve modelling the motion of pixels (or bins corresponding to those pixels) in a sequence of frames. Warping can be accomplished using motion vectors.

If per-bin motion vectors are available, “forward-warping” can be used to warp each bin with its motion vector to the focal deep image. This may be an effective technique, since it allows access to temporal neighbors for all bins even with heterogenous motion (e.g., with moving foreground objects in front of a static background). Forward warping also avoids duplicating or dropping bins, since in a deep image representation, each pixel can contain an arbitrary number of bins. If per-bin motion vectors are not available, per-pixel vectors can be used instead. Such per-pixel vectors can be extracted using optical flow, and can be applied to all bins in the corresponding pixels. When warping using per-pixel vectors, it may be more effective to use “back-warping”, as it may enable access to indirect neighbors.

In some embodiments, the computer system can use a different ragged tensor format for the multiscale networks and the mixing transformers. The multiscale networks may use a “frames-in-batch” form, while the mixing transformers 1518 and 1522 may use a “frames-in-bin” form. The computer system can reshape ragged tensors as needed between these two forms in order to generate deep image embedding 1512. For example, the computer system can reshape the output of the first multiscale network 1516 into a frames-in-bin form for the mixing transformer 1518, then reshape the output of the mixing transformer 1518 into a “frame-in-batch” form for the second multiscale network 1520. This reshaping technique can improve complexity scaling at high bin counts, reduce the cost of denoising, and improve denoising quality. The computer system can convert between these two representations using frame masks, which can comprise Boolean tensors that allow extraction of bins from each deep image in the sequence of deep images 1510, as another alternative, the computer system can use frame indices to convert between these two representations, which may be more efficient in some cases.

As described above, multiple ragged tensors corresponding to deep images can be concatenated in a batch dimension, resulting in a Batch (N)×Height (H)×Width (W)×Bin (B)×Channel (C) ragged tensor. In some embodiments, a synthetic feature corresponding to each deep image's offset from the focal deep image can also be generated (e.g., in initial processing block 1514) and appended to such ragged tensors. The frames-in-batch form may involve concatenating each deep image tensor in the sequence of deep images in the batch dimension, allowing independent processing of each deep image in the sequence of deep images 1510. The frames-in-bin form may involve concatenating each deep image tensor in the sequence of deep images 1510 in the bin dimension, allowing attention across all frames at once, enabling temporal mixing via mixing transformers 1518 and 1522.

Regardless, after initially processing the sequence of deep images 1510 using initial processing block 1514, the computer system can process the resulting ragged tensor using embedding sub-model 1502, e.g., by processing the ragged tensor using the first multiscale network 1516, mixing transformer 1518, second multiscale network 1520, and mixing transformer 1522, converting between frames-in-batch and frames-in-bin representations as necessary. As described above, mixing transformers 1518 and 1522 can to embed latent space features corresponding to one or more other deep images (in the sequence of deep images) in deep image embedding 1512. These latent space features can enable the computer system to use a denoising sub-model to temporally denoise the focal deep image temporally in addition to spatially. This can reduce flickering or other visual artifacts in animated sequences of deep images. Further, the information from neighboring deep images in the sequence of deep images can help the denoising sub-model denoise underlying image content structure (e.g., borders, corner points, etc.) in a deep image.

### VI. DENOISING SUB-MODEL

Having described various embedding sub-model architectures according to embodiments of the present disclosure, denoising methods, sub-models, and components of denoising sub-models are described below with reference to FIGS. 16-19.

FIG. 17 shows a denoising sub-model 1702 according to some embodiments. Denoising sub-model 1702 is a multiscale denoising sub-model comprising three levels, i.e., a full-scale level, a first downscale level 1710 and a second downscale level 1712. However, it should be understood that denoising sub-models according to embodiments can comprise any number of levels and downscale levels. Various numbers of scales, dropout patterns, dropout rates, blur and denoising radius, etc., as described below, can be used, and examples provided herein are intended to be non-limiting.

In general terms, the denoising sub-model can take a noisy deep image input 1704 and a deep image embedding 1706 (e.g., produced using an embedding sub-model) and produce a denoised deep image 1708. Generally, it does not matter whether the deep image embedding 1706 was generated by an embedding sub-model according to embodiments using local attention or produced via another source and another technique, provided that there is a correspondence between bin embeddings in the deep image embedding 1706 and bins in the deep image input 1704. Such correspondence may enable a computer system to denoise the deep image input 1704 using cross-attention. Much like the embedding sub-models described above, the denoising sub-model 1702 can use novel local attention mechanisms in order to perform its functions.

Denoising sub-model 1702 generally comprises a single “reconstruction block”, which may also be referred to as a “layer block”. However, it should be understood that denoising sub-models according to embodiments can also comprise multiple reconstruction blocks or layer blocks. Each reconstruction block can generally comprise the components illustrated in the denoising sub-model 1702 of FIG. 17, e.g., downscaling layers, blur attention elements, denoise attention elements, etc. As such, although the description below generally focuses on the components and functions of a single reconstruction block, denoising sub-models comprising multiple reconstruction blocks according to embodiments can also be understood with reference to FIG. 17 and the description below. When reference is made to a component or element of the denoising sub-model 1702, such as blur attention element 1718, it should be understood that each reconstruction block in a denoising sub-model could comprise such a component or element, and thus denoising sub-model 1702 can comprise multiple instances of the components or elements depicted in FIG. 17, each of which may perform operations described herein with reference to a single described element.

In general, multiple reconstruction blocks can be used to denoise deep images comprising multiple layers. For example, in some embodiments, each deep image layer can be denoised using a different reconstruction block. Various deep image layers, including color layers, diffuse layers, specular layers, depth layers, alpha layers, etc., can be denoised in this manner. Denoising deep images using different reconstruction blocks may be useful as the semantic contents of each deep image layer may be different. For example, the processes of denoising a color layer (e.g., by adjusting the color at different bins in the deep image) and denoising a depth layer (e.g., by adjusting the depth or position of different bins in the deep image) may be sufficiently different that higher denoising quality may be achieved by denoising these two layers independently, e.g., using two different reconstruction blocks.

Each reconstruction block can be configured and parameterized differently, enabling each layer to be denoised differently. For example, each reconstruction block can be parameterized with different numbers of downscale levels, different downscaling factors, different dropout patterns, different full-scale and downscale distances to define full-scale and downscaled local bin sets, etc. For example, a depth layer could be denoised with a single full-scale level, while an alpha layer may be denoised with a full-scale level and multiple downscale levels. Likewise, alpha layers may be denoised with a downscaling factor of 50%, rather than 25% as depicted in FIG. 17. For single scale depth denoising, such downscaling factors may not be applicable.

As described above with reference to FIG. 7, after generating a deep image embedding using embedding sub-model, at step 712 a computer system can denoise a deep image input using the deep image embedding. FIG. 16 shows a flowchart of a method for denoising a deep image using an denoising sub-model (such as denoising sub-model 1702) according to some embodiments.

At step 1602, the computer system can acquire and initially process the deep image input 1704, if necessary. As described above, a deep image according to embodiments can comprise a plurality of bins organized into one or more layers (e.g., color layers, depth layers, alpha layers, diffuse and specular layers, etc.). In some embodiments, each bin can correspond to one or more layer values that correspond to the one or more layers. As described above, a “layer value” generally refers to a value associated with a given layer in a deep images, including a value associated with a given channel of the layer. For example, a bin can comprise color layer values, such as red, green, and blue color channels. The computer system may initially process the deep image input 1704 such that the embedding sub-model 1702 can better use this bin data for the purpose of denoising deep images.

The computer system can provide the noisy deep image input 1704 to the denoising sub-model in the same way as noisy per-bin features can be provided to the embedding sub-model, e.g., via a tensor that can be constructed by concatenating features in a bin dimension. This can create a direct correspondence between bin embeddings in the deep image input 1704 and the deep image embedding 1706, enabling deep image denoising based on cross-attention. In more detail, the denoising sub-model can use the deep image embedding 1706 to generate keys and queries. Cross-attention can be evaluated between these keys, queries, and values derived from the deep image input 1704 (e.g., using attention elements such as blur attention elements 1718 and 1720 and denoising attention elements 1722-1726). The result of these cross-attention operations can comprise intermediate denoised deep images 1734, which can be combined using a linear blend layer 1728 in order to produce the denoised deep image 1708. As described above, the embedding sub-model 1702 can comprise multiple layer blocks (or reconstruction blocks) which may be used to denoise different layers of the deep image input 1704. As such, the denoised deep image 1708 can comprise denoised deep image layers produced by the linear blend layers of multiple reconstruction blocks.

Regardless, at step 1604, the computer system can optionally downscale the deep image embedding 1706 based on one or more downscaling factors. In this way, the computer system can generate one or more downscaled deep image embeddings, e.g., downscaled deep image embeddings 1730 and 1732 in FIG. 17. The one or more downscaled deep image embeddings 1730 and 1732 and the one or more downscaling factors can correspond to one or more downscale levels, e.g., a first downscale level 1710 and a second downscale level 1712. The computer system can perform these downscaling operations via downscaling layers 1714 and 1716.

Downscaling operations and downscaling layers 1714 and 1716 can generally be understood with reference to the description of downscaling further above, e.g., with reference to downscaling layers 1228 and 1230 of FIG. 12. As described above, the computer system can implement downscaling via fixed function, random or regular per-bin or per-pixel dropout, or using any other appropriate downscaling technique. These downscaling operations can result in a series of consecutively more sparse downscaled deep image embeddings 1730 and 1732, which may be the same logical size as the deep image embedding 1706. For example, downscaled deep image embedding 1730 can comprise 25% of the bin embeddings from deep image embedding 1706, while downscaled deep image embedding 1732 can comprise 6.25% of the bin embeddings from deep image embedding 1706.

At step 1606, the computer system can determine one or more pluralities of local bin embedding sets corresponding to the deep image embedding 1706. As depicted in FIG. 17, the denoising sub-model can comprise a multiscale network (e.g., comprising a full-scale level and one or more downscale levels, e.g., first downscale level 1710 and second downscale level 1712) which may correspond to one or more downscaling factors. The one or more plurality of local bin embedding sets can likewise correspond to these one or more downscaling factors, e.g., the one or more pluralities of local bin embedding sets can comprise a plurality of full-scale local bin embedding sets and one or more downscaled local bin embedding sets, e.g., a first downscaled local bin embedding set corresponding to the first downscale level 1710 and a second downscaled local bin embedding set corresponding to the second downscale level 1712.

The computer system can determine each plurality of full-scale local bin embedding sets based on the deep image embedding 1706 and one or more pluralities of downscaled local bin embedding sets based on the one or more downscaled deep image embeddings (e.g., downscaled deep image embeddings 1730 and 1732). Each local bin embedding set can comprise a plurality of local bin embeddings derived from the deep image embedding and a respective focal bin embedding. Each plurality of local bin embeddings can be within a specified distance of the respective focal bin embedding. For example, such specified distances can comprise specified radiuses that define circular local regions (or e.g., conic local regions). A given local bin embedding set can comprise bins within such circular local regions. As such, in some embodiments each full-scale local bin embedding set can correspond to a circular full-scale local region defined by a specified radius value, and each downscaled local bin embedding set can correspond to a circular downscaled local region defined by a specified downscaled radius value.

As described above with reference to FIG. 12, in some embodiments, specified distances used to define local regions can be progressively larger with each successive downscaling level. For example, a full-scale specified distance could comprise a distance of 1.5 grid cells, while a first downscaled specified distance (corresponding to first downscale level 1710) could comprise a distance of 2.5 grid cells, and a second downscaled specified distance (corresponding to second downscale level 1712) could comprise a specified distance of 4.5 grid cells. By increasing the specified distances in this manner, downscaled local bin embedding sets can comprise roughly the same number of bin embeddings, even though the downscaled deep image embeddings (e.g., downscaled deep image embeddings 1730 and 1732) used to derive these local bin embedding sets are progressively more sparse due to downscaling layers 1714 and 1716.

The process for determining these local bin embedding sets may be similar to the process for determining initial downscaled local bin embedding sets described above with reference to FIGS. 7 and 12, and can generally be understood with reference to that description. Generally, the computer system can iterate through each bin embedding in the deep image embedding 1706 and select that bin embedding as a focal bin embedding. The computer system can then identify a plurality of other bin embeddings within a local region containing that focal bin embedding. Examples of such local regions were described above with reference to FIGS. 4A-4D. For example, the computer system can identify bin embeddings that are within a specified distance of the focal bin embedding. In some embodiments, the computer system can use positional encodings (e.g., sine encodings) to evaluate the distances between bin embeddings for this purpose. The focal bin embedding and the identified bin embeddings can comprise a full-scale local bin embedding set. By performing this process for each bin embedding in the deep image embedding, the computer system can determine a plurality of full-scale local bin embedding sets. This process can also be performed for each downscaled bin embedding in the one or more downscaled deep image embeddings. In this way the computer system can determine one or more pluralities of downscaled local bin embedding sets.

At step 1608, the computer system can use denoising sub-model 1702 to generate one or more intermediate denoised deep images 1734. The denoising sub-model 1702 can implement local cross-attention based denoising to generate the one or more intermediate denoised deep images 1734, e.g., via blur attention elements 1718 and 1720 and denoise attention elements 1722-1726. This can be implemented using cross-attention based denoising. Such intermediate denoised deep images can be combined, e.g., using a linear blending layer 1728 in order to generate the denoised deep image 1708. In general terms, the computer system can generate the one or more intermediate denoised deep images based on cross-attention between each bin of the deep image input 1704 and one or more corresponding local bin embedding sets corresponding to each bin, e.g., determined at step 1606. Each intermediate denoised deep image can comprise a plurality of intermediate denoised bins.

As described above, in some embodiments the denoising sub-model 1702 can comprise one or more layer blocks (or reconstruction blocks) corresponding to one or more layers of the deep image input 1704. Each layer block can be used to denoise a different layer of the deep image input 1704. In such cases, the intermediate denoised deep images 1734 can be generated on a per-layer basis using the one or more layer blocks. For example, each intermediate denoised deep image 1734 may comprise one or more intermediate denoised deep image layers corresponding to the one or more layers.

In some embodiments, the one or more intermediate denoised deep images can comprise a full-scale intermediate denoised deep image and one or more downscaled intermediate denoised deep images, which can correspond to one or more downscaling factors and/or downscaling layers. For example, a first intermediate denoised deep image can correspond to first downscale level 1710 and a second intermediate denoised deep image can correspond to second downscale level 1712. As such, step 1608 can involve the computer system generating the full-scale intermediate denoised deep image and generating the one or more downscaled denoised deep images. These operations can be performed in steps 1610-1616, which may comprise sub-steps of step 1608.

At step 1610, the computer system can generate a full-scale intermediate denoised deep using a full-scale denoising attention element, e.g., denoising attention element 1722 in FIG. 17, which can be used to implement local attention based denoising. Using denoising attention element 1722, the computer system can generate the full-scale denoised deep image based on cross-attention between each bin of the plurality of bins (in the deep image input 1704) and a corresponding full-scale local bin embedding set of the plurality of full-scale local bin embeddings sets (e.g., determined at step 1606), thereby generating a plurality of full-scale intermediate denoised bins. The full-scale intermediate denoised deep image can comprise the plurality of full-scale intermediate denoised bins. For denoising sub-models comprising multiple layer blocks (or reconstruction blocks), cross-attention can be computed for each individual layer of each bin.

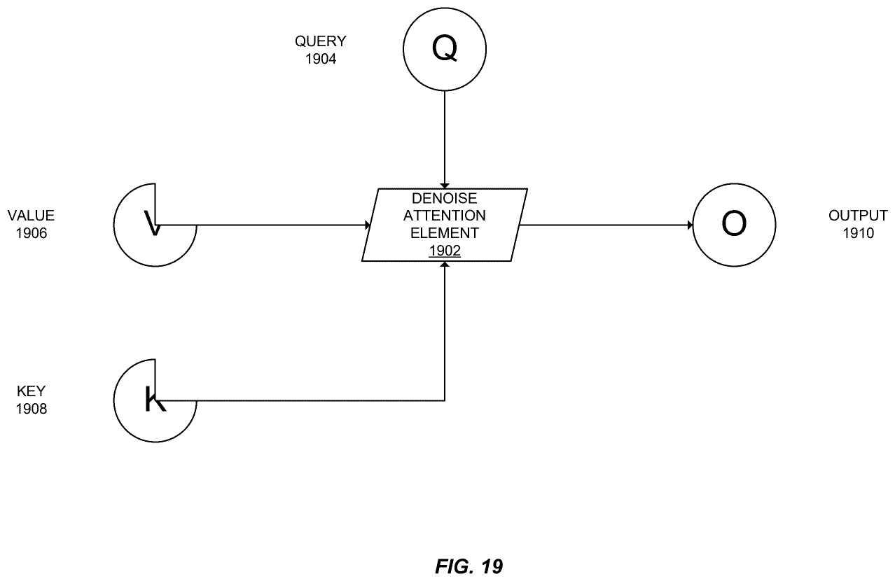

Denoise attention elements and step 1610 may be better understood with reference to denoise attention element 1902 of FIG. 19. In some embodiments, denoise attention element 1902 may comprise a local attention element similar to the local attention elements described above (e.g., with reference to FIG. 11) and may not comprise a transformer, as it does not include a residual path or linear layer (e.g., as depicted in local attention transformer 1002 of FIG. 10). Denoise attention elements, such as denoise attention element 1902 can implement local cross-attention between a query 1904, value 1906, and key 1908. In such cases, the value 1906 may comprise raw noisy deep image data, e.g., per-bin features corresponding to noisy deep image layers (e.g., color data, alpha, depth, diffuse, specular, etc.), rather than bin embeddings. In some embodiments, no weight matrix is used to generate the value 1906. The query 1904 and key 1908 may be derived from the bin embeddings from local bin embedding sets, e.g., via optional weight matrices.

The output 1910 of the denoise attention element 1902 may comprise an intermediate denoised deep image corresponding to a respective level of the denoising sub-model 1702. For example, denoise attention element 1722 can be used to generate a full-scale intermediate denoised deep image, while denoising attention element 1724 (corresponding to the first downscale level 1710) can be used to produce a first downscaled intermediate denoised deep image and denoising attention element 1726 can be used to produce a second downscaled denoised deep image, as described in more detail further below. Notably, unlike local attention elements used in the embedding sub-model, the output 1910 may not comprise bin embeddings, and may instead comprise denoised deep image bins that make up the intermediate denoised deep images.

Denoise attention element 1902 can use a full-scale query 1904 to generate intermediate denoised deep images, e.g., comprising non-downscaled local bin sets derived from a deep image embedding (e.g., deep image embedding 1706). By contrast, the value 1906 and key 1908 may be different scales depending on whether the computer system is using the denoise attention element 1902 to generate a full-scale intermediate denoised deep image or a downscaled intermediate denoised deep image. When generating a full-scale denoised deep image, the value 1906 and key 1908 may be full-scale, e.g., derived from full-scale bins from a noisy deep image input and full-scale local bin embedding sets from a deep image embedding. However, when generating a downscaled denoised deep image, the value 1906 and key 1908 may be downscaled. In such cases, the value 1906 may comprise a blurred deep image (which may be generated using a blur attention element, as described further below), and the key 1908 may be derived from a downscaled local bin embedding set.

Generally, the value 1906 and key 1908 may have corresponding to the same level of the embedding sub-model 1702 and may have the same “bin shape”, while the query 1904 and key 1908 may have the same “feature shape,” but may not necessary correspond to the same level of the embedding sub-model 1702. The output 1910 may have the same bin layout as the query 1904 bin layout. The dimensionality of output per-bin feature vectors may be determined based on the feature dimensionality of the value 1906.

At step 1612, the computer system can generate a blurred deep image for each downscaled deep image embedding. For example, the computer system can generate a first blurred deep image using downscaled deep image embedding 1730 and a second blurred deep image using downscaled deep image embedding 1732. The computer system can use one or more blur attention elements corresponding to the one or more downscaling factors to generate the one or more blurred deep images. For example, the computer system can use blur attention element 1718, corresponding to a first downscale factor and first downscale level 1710 to generate a first blurred deep image, and can use blur attention element 1720, corresponding to a second downscale factor and second downscale level 1712 to generate a second blurred deep image. The computer system can generate these blurred deep images based on cross-attention between each bin of the plurality of bins and one or more corresponding downscaled local bin embedding sets.

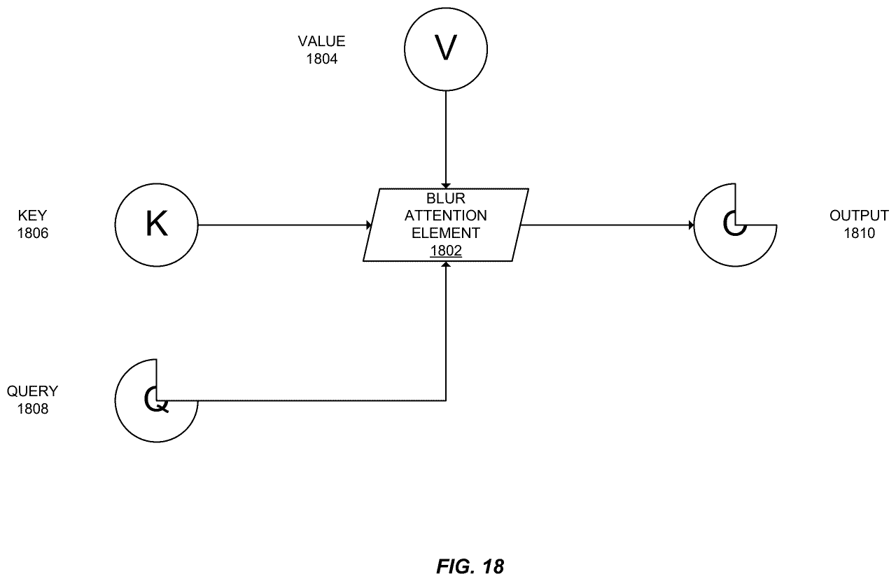

Blur attention elements, and step 1612 may be better understood with reference to blur attention element 1802 of FIG. 18. In some embodiments, blur attention element 1802 may comprise a local attention element similar to local attention elements described above (e.g., with reference to FIG. 11) and may not comprise a transformer, as it does not include a residual path or linear layer (e.g., as depicted in local attention transformer 1002 of FIG. 10).

Blur attention element 1802 can implement local cross-attention between a value 1804, key 1806, and query 1808. The value 1804 may comprise raw noisy deep image data, e.g., per-bin features corresponding to noisy deep image layers (e.g., color data, alpha, depth, diffuse, specular, etc.) rather than bin embeddings. In some embodiments, no weight matrix is used to generate the value 1804. Referring to both FIGS. 17 and 18, the value 1804 may be generated from either the deep image input 1704 or from a blur attention element. For example, for blur attention element 1718, the value 1804 may be generated from the deep image input 1704, while for blur attention element 1720, the value 1804 may be generated from the output of blur attention element 1718. The key 1806 and query 1808 may be derived from the bin embeddings from local bin embedding sets, e.g., via optional weight matrices.

The output 1810 of blur attention element 1802 may comprise a blurred deep image corresponding to a respective downscale level of the denoising sub-model. For example, blur attention element 1718 can be used to produce a first blurred deep image, while blur attention element 1720 can be used to produce a second blurred deep image. Notably, unlike local attention elements used in the embedding sub-model, the output 1810 may not comprise bin embeddings, and may instead comprise blurred deep image bins that make up the blurred deep images.

Unlike the denoise attention element described above with reference to FIG. 19, for blur attention element 1802, the key 1806 and query 1808 may correspond to different levels of the embedding sub-model. For example, for blur attention element 1718, the key 1806 may comprise full-scale bin embeddings from the deep image embedding 1706, while the query 1808 may comprise downscaled bin embeddings from downscaled deep image embedding 1730. Likewise, for blur attention element 1720, the key 1806 may comprise downscaled bin embeddings from downscaled deep image embedding 1730, while the query 1808 may comprise downscaled bin embeddings from downscaled deep image embedding 1732.

As described above, the computer system can use denoise attention elements to generate the downscaled denoised deep images using blurred deep images generated via the blur attention elements. Such denoise attention elements may perform local attention on local bin sets. As such, at step 1614, the computer system can determine a plurality of blurred local bin sets for each blurred deep image of the one or more blurred deep images. Each blurred local bin set can comprise a plurality of blurred local bins from a corresponding blurred deep image. In some embodiments, each plurality of blurred local bins can be within a specified distance of a respective blurred focal bin. For example, such specified distances can comprise specified radiuses that define circular local regions. A given blurred local bin set can comprise bins within such a circular local region. As described above, specified distances used to define local regions can be progressively larger with each successive downscaling level. For example, a specified distance associated with blur attention element 1718 could comprise 1.5 grid cells, while a specified distance associated with blur attention element 1720 could comprise 2.5 grid cells.

The process for determining these blurred local bin sets may be similar to processes for determining local bin sets and initial downscaled local bin embedding sets, as described above with reference to FIGS. 7, 12, 16, and 17, and can generally be understood with reference to that description. Generally, the computer system can iterate through each blurred bin in each blurred deep image and select that blurred bin as a blurred focal bin. The computer system can then identify a plurality of other blurred bins within a downscaled denoising local region containing that blurred focal bin. Examples of such local regions were described above with reference to FIGS. 4A-4D. For example, the computer system can identify bin embeddings that are within a specified distance of the blurred focal bin. In some embodiments, the blurred local bin sets may comprise bins within respective circular regions (or respective conic regions, or any other appropriate local regions) defined by respective specified radius values (which may be referred to as “downscaled denoising radius values”), which may comprise specified downscaled distances. In some embodiments, the computer system can use positional encodings (e.g., sine encodings) to evaluate the distances between blurred bins for this purpose. The blurred focal bin and the identified blurred bins can comprise a blurred local bin set. By performing this process for each blurred bin in the blurred deep images, the computer system can determine the one or more pluralities of blurred local bin sets.

At step 1616, the computer system can generate one or more intermediate downscaled denoised deep images based on the one or more pluralities of blurred local bin sets. Each intermediate downscaled denoised deep image can comprise a plurality of downscaled denoised bins. The computer system can use one or more denoising attention elements corresponding to one or more downscaling factors to generate the one or more intermediate downscaled denoised deep images for each plurality of blurred local bin sets of the one or more pluralities of blurred local bin sets. For example, the computer system can use denoising attention element 1724 to generate a first intermediate downscaled denoised deep image corresponding to first downscale level 1710 (and a first downscaling factor) using a first blurred local bin set (which may be generated using blur attention element 1718, e.g., at step 1612 of FIG. 16). Likewise, the computer system can use denoising attention element 1726 to generate a second intermediate downscaled deep image corresponding to second downscale level 1712 (and a second downscaling factor) using a second blurred local bin set (which may be generated using blur attention element 1720, e.g., at step 1612 of FIG. 16).

As described above with reference to FIG. 19, the computer system can generate intermediate downscaled denoised deep images based on cross-attention between a query 1904, value 1906, and key 1908. In some embodiments, the value 1906 may comprise a blurred local bin set, the key 1908 may comprise a corresponding downscaled local bin embedding set, and the query 1904 may comprise a corresponding full-scale local bin embedding set. For example, when generating an intermediate downscaled denoised deep image using denoising attention element 1724, the computer system can use a full-scale queries derived from the deep image embedding 1706, values comprising blurred local bin sets comprising blurred bins generated using blur attention element 1718, and keys comprising downscaled local bin embedding sets derived from downscaled deep image embedding 1730. Likewise, when generating an intermediate downscaled denoised deep image using denoising attention element 1726, the computer system can use full-scale queries derived from deep image embedding 1706, values comprising blurred local bin sets comprising blurred bins generated using blur attention element 1720, and keys comprising downscaled local bin embedding sets derived from downscaled deep image embedding 1732. Each intermediate downscaled denoised deep image can reconstruct different levels of detail in the deep image input 1704, which can result in a higher quality denoised deep image when combined with a full-scale intermediate denoised deep image, e.g., as described below.

At step 1618, the computer system can generate the denoised deep image 1708 based on the one or more intermediate denoised deep images 1734. In some embodiments, the computer system can generate the denoised deep image 1708 by combining the one or more intermediate denoised 1738 using a linear blending layer 1728. Such a linear blending layer can comprise two or more dense neural network layers with a softmax activation function applied to full resolution denoised deep image features. Generally, the linear blending layer 1728 can predict blend factors to combine the intermediate denoised deep images 1734 from different downscale levels. Such intermediate denoised deep images 1734 may have the same bin structure, but different content, e.g., the lowest downscale level intermediate denoised deep image may be blurrier than the full-scale intermediate denoised deep image. The linear blending layer 1728 may perform a function similar to a one by one convolution in a convolutional network, enabling computation on the features within each bin. As described above, denoising sub-model 1702 can comprise one or more layer blocks (also referred to as “reconstruction blocks”) corresponding to the one or more layers. As such, the computer system may use one or more linear blending layers from the one or more layer blocks to generate one or more denoised deep image layers, and these one or more deep images layers can be combined to produce the denoised deep image 1708. In some embodiments, the linear blending layer 1728 may comprise the largest source of trainable weights in the machine learning model.

### VII. TRAINING

A method according to embodiments of the present disclosure for training a machine learning model (which as described above may comprise an embedding sub-model and a denoising sub-model) to denoise deep images is described below with reference to FIG. 20.

After retrieving a training data set (e.g., from a database, a data stream, a local memory element such as a hard drive, cloud storage, an I/O interface, or any other appropriate source), which can comprise a plurality of training deep images, at step 2002 a computer system can perform a round of an iterative training process. The round of the iterative training process can comprise steps 2004-2020, described in more detail below. The computer system can perform this iterative training process until a terminating condition has been met, e.g., a set number of training rounds or epochs, a convergence condition, or any other appropriate terminating condition.

The training deep images can comprise noisy deep images, which can be generated via Monte Carlo rendering techniques such as path tracing, e.g., at a low number of samples per pixel. Each training deep image can comprise a plurality of training bins. Each training deep image can correspond to a reference deep image, which may comprise a “clean” (i.e., non-noisy) deep image depicting the same subject as a corresponding training deep image. Such reference deep images can be generated via Monte Carlo rendering techniques such as path tracing, e.g., at a high number of samples per pixel.

When training a machine learning model to temporally denoise deep images in addition to spatially denoising deep images, the training data set can comprise training sequences of deep images, e.g., sequentially rendered deep image frames of an animated film. A training sequence of noisy deep image frames can comprise a focal deep image (e.g., the center deep image in the sequence of frames) and some number of other deep images, e.g., preceding and following the focal deep image in the training sequence. These other deep images can be indexed by an offset from the focal deep image. Such a training sequence can be paired with a single clean reference deep image corresponding to the focal deep image. In such cases, the focal deep image can be denoised and the loss can be calculated with reference to the clean reference deep image.

At step 2004, the computer system can sample a batch of training deep images. The batch of training deep images can comprise one or more training deep images from the training data set. As described above with reference to the embedding sub-model, the computer system can perform initial processing operations on the batch of training deep images. Via this initial processing, the computer system can produce Height (H)×Width (W)×Bin (B)×Channel (C) tensors corresponding to each training deep image in the batch of training deep images. These tensors can be concatenated together to produce a Batch (N)×Height (H)×Width (W)×Bin (B)×Channel (C) tensor, which can be used as an input to local attention transformers in the embedding sub-model.

At step 2006, the computer system can use the embedding sub-model to generate a training deep image embedding for each training deep image of the one or more training deep images. In this way the computer system can generate one or more training deep images. The process of generating the one or more training deep images (i.e., step 2006) can generally be understood with reference to the description of the embedding sub-model and the flowchart of FIG. 7 above. Step 2006 can comprise sub-steps 2008-2012.

At step 2008, for each training deep image, the computer system can determine a plurality of local bin sets corresponding to a plurality of training bins corresponding to that training deep image. Each local bin set can comprise a plurality of local bins from the plurality of training bins and a respective focal training bin. Additionally, each plurality of local bins can be within a specified distance of the respective focal training bin. In some embodiments, a specified distance can comprise a radius that defines a circular local region containing the focal training bin and the plurality of local bins. As described above with reference to FIGS. 7 and 8, the computer system can use any appropriate means to determine the plurality of local bin sets, e.g., by using positional encodings (which may be generated during initial processing operations) to identify training bins within the specified distance of a respective focal training bin.

At step 2010, the computer system can use the embedding sub-model to generate a training bin embedding for each focal training bin, thereby generating a plurality of training embeddings. As described above with reference to FIGS. 7 and 8, the computer system can generate these training bin embeddings based on attention of a corresponding local bin set, e.g., using local attention transformer components of the embedding sub-model.

At step 2012, the computer system can generate a training deep image embedding based on the plurality of training bin embeddings. In this way the computer system can generate the one or more training deep image embeddings. As described above, this can be accomplished in various ways depending on the architecture of the embedding sub-model. For a single scale embedding sub-model (e.g., as depicted in FIG. 8), the one or more training deep image embeddings can each comprise a corresponding plurality of training bin embeddings, and no additional processing may be needed to generate the training deep image embedding. By contrast, for a multiscale network embedding sub-model (e.g., as depicted in FIG. 12), each plurality of training bin embeddings can comprise a plurality of full-scale training bin embeddings and one or more pluralities of downscaled training bin embeddings (e.g., corresponding to one or more downscale levels). In such cases, the computer system can generate the training deep image embedding by combining the plurality of full-scale training bin embeddings and the one or more pluralities of downscaled training bin embeddings, e.g., using a sub-model of the embedding sub-model, as described above with reference to FIG. 12.

At step 2014, for each training deep image, the computer system can generate a denoised training deep image. In this way the computer system can generate one or more denoised training deep images. The computer system can generate the one or more denoised training deep images using the denoising sub-model, e.g., by applying a training deep image and a corresponding training deep image embedding to the denoising sub-model. Using the denoising sub-model, the computer system can generate a plurality of denoised training bins for each training deep image. Each denoised training deep image can comprise a corresponding plurality of denoised training bins. Steps for generating the one or more denoised training deep images, e.g., downscaling training deep image embeddings based on one or more downscale levels, using blur attention elements and denoise attention elements, combining intermediate denoised deep images using a linear blending layer, etc., can be better understood with reference to the description of FIGS. 16 and 17 above.

At step 2016, the computer system can determine one or more loss values based on the one or more denoised training deep images. The one or more loss values can be determined by comparing the one or more denoised training deep images to the one or more reference deep images, e.g., the losses can be based on differences between the denoised deep images and the corresponding clean reference deep images. If the denoised training deep images are similar to the one or more reference deep images (indicating generally successful deep image denoising), then the loss values may be low, while if the denoised training deep images are dissimilar to the one or more reference deep images, the loss values may be high. Various statistical metrics can be used as loss values or used to derived loss values, such as the mean-squared error. As described above, for a machine learning model used to temporally denoise deep images, training deep images from the batch of training deep images may comprise sequences of noisy deep images, e.g., centered on a focal deep image. In such a case, a loss value corresponding to the sequence of deep images may be calculated by comparing the denoised focal deep image to a reference deep image.

At step 2018, the computer system can update a parameter set of the machine learning model based on the one or more loss values. In this way, the computer system can train the machine learning model. As described above, a machine learning model according to embodiments can comprise an embedding sub-model and a denoising sub-model, which each may possess their own set of parameters. As such, in some embodiments, updating the parameter set based on the one or more loss values can comprise updating an embedding sub-model parameter set and a denoising sub-model parameter set. The computer system can use any appropriate technique for updating the parameter set, such as using stochastic gradient descent to determine differential changes in the model parameters that result in the greatest immediate reduction to the one or more loss values produced at step 2016. In some embodiments, the computer system can accomplish step 2016 by backpropagating the one or more loss values. In some implementations of machine learning models according to embodiments, the denoising sub-model linear blending layer may comprise the largest source of trainable weights in the machine learning model and linear layers associated with local attention transformers may comprise the second largest source of trainable weights. Generally, step 2018 may comprise the most computationally expensive part of the training process.

At step 2020, the computer system can determine if a terminating condition has been met. As described above, in some embodiments, the terminating can comprise a defined number of training rounds, and the terminating condition can be met if a total number of training rounds performed equals or exceeds the defined number of training rounds. In other embeddings, the terminating condition can comprise a convergence condition. This terminating condition can be met if the set of model parameters converge, e.g., exhibit little to no change in consecutive training rounds. If the terminating condition has not been met, the computer system can return to step 2002 and repeat the iterative training process until the terminating condition has been met, e.g., by sampling a new batch of training deep images. Otherwise at step 2022 the computer system can complete the iterative training process. At this point, the parameters of the machine learning model can be fixed, and the machine learning model can be used to generate deep image embeddings and denoise deep images, e.g., as described above with reference to the embedding sub-model and denoising sub-model.

### VIII. COMPUTER SYSTEM

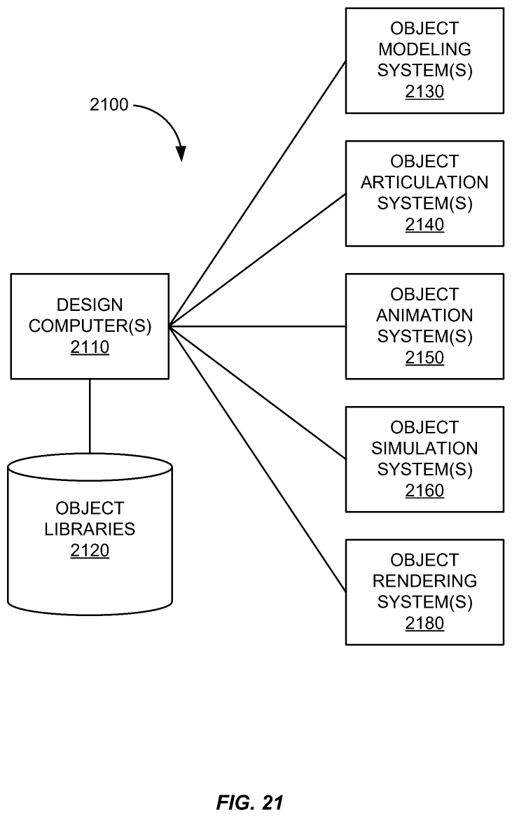

FIG. 21 is a simplified block diagram of system 2100 for creating computer graphics imagery (CGI) and computer-aided animation that may implement or incorporate various embodiments. In this example, system 2100 can include one or more design computers 2110, object library 2120, one or more object modeling systems 2130, one or more object articulation systems 2140, one or more object animation systems 2150, one or more object simulation systems 2160, and one or more object rendering systems 2170. Any of the systems 2130-2170 may be invoked by or used directly by a user of the one or more design computers 2110 and/or automatically invoked by or used by one or more processes associated with the one or more design computers 2110. Any of the elements of system 2100 can include hardware and/or software elements configured for specific functions.

The one or more design computers 2110 can include hardware and software elements configured for designing CGI and assisting with computer-aided animation. Each of the one or more design computers 2110 may be embodied as a single computing device or a set of one or more computing devices. Some examples of computing devices are PCs, laptops, workstations, mainframes, cluster computer system, grid computer systems, cloud computer systems, embedded devices, computer graphics devices, gaming devices and consoles, consumer electronic devices having programmable processors, or the like. The one or more design computers 2110 may be used at various stages of a production process (e.g., pre-production, designing, creating, editing, simulating, animating, rendering, post-production, etc.) to produce images, image sequences, motion pictures, video, audio, or associated effects related to CGI and animation.

In one example, a user of the one or more design computers 2110 acting as a modeler may employ one or more systems or tools to design, create, or modify objects within a computer-generated scene. The modeler may use modeling software to sculpt and refine a neutral 3D model to fit predefined aesthetic needs of one or more character designers. The modeler may design and maintain a modeling topology conducive to a storyboarded range of deformations. In another example, a user of the one or more design computers 2110 acting as an articulator may employ one or more systems or tools to design, create, or modify controls or animation variables (avers) of models. In general, rigging is a process of giving an object, such as a character model, controls for movement, therein “articulating” its ranges of motion. The articulator may work closely with one or more animators in rig building to provide and refine an articulation of the full range of expressions and body movement needed to support a character's acting range in an animation. In a further example, a user of design computer 2110 acting as an animator may employ one or more systems or tools to specify motion and position of one or more objects over time to produce an animation.

Object library 2120 can include elements configured for storing and accessing information related to objects used by the one or more design computers 2110 during the various stages of a production process to produce CGI and animation. Some examples of object library 2120 can include a file, a database, or other storage devices and mechanisms. Object library 2120 may be locally accessible to the one or more design computers 2110 or hosted by one or more external computer systems.

Some examples of information stored in object library 2120 can include an object itself, metadata, object geometry, object topology, rigging, control data, animation data, animation cues, simulation data, texture data, lighting data, shader code, or the like. An object stored in object library 2120 can include any entity that has an n-dimensional (e.g., 2D or 3D) surface geometry. The shape of the object can include a set of points or locations in space (e.g., object space) that make up the object's surface. Topology of an object can include the connectivity of the surface of the object (e.g., the genus or number of holes in an object) or the vertex/edge/face connectivity of an object.

The one or more object modeling systems 2130 can include hardware and/or software elements configured for modeling one or more objects. Modeling can include the creating, sculpting, and editing of an object. In various embodiments, the one or more object modeling systems 2130 may be configured to generate a model to include a description of the shape of an object. The one or more object modeling systems 2130 can be configured to facilitate the creation and/or editing of features, such as non-uniform rational B-splines or NURBS, polygons and subdivision surfaces (or SubDivs), that may be used to describe the shape of an object. In general, polygons are a widely used model medium due to their relative stability and functionality. Polygons can also act as the bridge between NURBS and SubDivs. NURBS are used mainly for their ready-smooth appearance and generally respond well to deformations. SubDivs are a combination of both NURBS and polygons representing a smooth surface via the specification of a coarser piecewise linear polygon mesh. A single object may have several different models that describe its shape.

The one or more object modeling systems 2130 may further generate model data (e.g., 2D and 3D model data) for use by other elements of system 2100 or that can be stored in object library 2120. The one or more object modeling systems 2130 may be configured to allow a user to associate additional information, metadata, color, lighting, rigging, controls, or the like, with all or a portion of the generated model data.

The one or more object articulation systems 2140 can include hardware and/or software elements configured to articulating one or more computer-generated objects. Articulation can include the building or creation of rigs, the rigging of an object, and the editing of rigging. In various embodiments, the one or more articulation systems 2140 can be configured to enable the specification of rigging for an object, such as for internal skeletal structures or eternal features, and to define how input motion deforms the object. One technique is called “skeletal animation,” in which a character can be represented in at least two parts: a surface representation used to draw the character (called the skin) and a hierarchical set of bones used for animation (called the skeleton).

The one or more object articulation systems 2140 may further generate articulation data (e.g., data associated with controls or animations variables) for use by other elements of system 2100 or that can be stored in object library 2120. The one or more object articulation systems 2140 may be configured to allow a user to associate additional information, metadata, color, lighting, rigging, controls, or the like, with all or a portion of the generated articulation data.

The one or more object animation systems 2150 can include hardware and/or software elements configured for animating one or more computer-generated objects. Animation can include the specification of motion and position of an object over time. The one or more object animation systems 2150 may be invoked by or used directly by a user of the one or more design computers 2110 and/or automatically invoked by or used by one or more processes associated with the one or more design computers 2110.

In various embodiments, the one or more animation systems 2150 may be configured to enable users to manipulate controls or animation variables or utilized character rigging to specify one or more key frames of animation sequence. The one or more animation systems 2150 generate intermediary frames based on the one or more key frames. In some embodiments, the one or more animation systems 2150 may be configured to enable users to specify animation cues, paths, or the like according to one or more predefined sequences. The one or more animation systems 2150 generate frames of the animation based on the animation cues or paths. In further embodiments, the one or more animation systems 2150 may be configured to enable users to define animations using one or more animation languages, morphs, deformations, or the like.

The one or more object animations systems 2150 may further generate animation data (e.g., inputs associated with controls or animations variables) for use by other elements of system 2100 or that can be stored in object library 2120. The one or more object animations systems 2150 may be configured to allow a user to associate additional information, metadata, color, lighting, rigging, controls, or the like, with all or a portion of the generated animation data.

The one or more object simulation systems 2160 can include hardware and/or software elements configured for simulating one or more computer-generated objects. Simulation can include determining motion and position of an object over time in response to one or more simulated forces or conditions. The one or more object simulation systems 2160 may be invoked by or used directly by a user of the one or more design computers 2110 and/or automatically invoked by or used by one or more processes associated with the one or more design computers 2110.

In various embodiments, the one or more object simulation systems 2160 may be configured to enables users to create, define, or edit simulation engines, such as a physics engine or physics processing unit (PPU/GPGPU) using one or more physically-based numerical techniques. In general, a physics engine can include a computer program that simulates one or more physics models (e.g., a Newtonian physics model), using variables such as mass, velocity, friction, wind resistance, or the like. The physics engine may simulate and predict effects under different conditions that would approximate what happens to an object according to the physics model. The one or more object simulation systems 2160 may be used to simulate the behavior of objects, such as hair, fur, and cloth, in response to a physics model and/or animation of one or more characters and objects within a computer-generated scene.

The one or more object simulation systems 2160 may further generate simulation data (e.g., motion and position of an object over time) for use by other elements of system 2100 or that can be stored in object library 2120. The generated simulation data may be combined with or used in addition to animation data generated by the one or more object animation systems 2150. The one or more object simulation systems 2160 may be configured to allow a user to associate additional information, metadata, color, lighting, rigging, controls, or the like, with all or a portion of the generated simulation data.

The one or more object rendering systems 2170 can include hardware and/or software element configured for “rendering” or generating one or more images of one or more computer-generated objects. “Rendering” can include generating an image from a model based on information such as geometry, viewpoint, texture, lighting, and shading information. The one or more object rendering systems 2170 may be invoked by or used directly by a user of the one or more design computers 2110 and/or automatically invoked by or used by one or more processes associated with the one or more design computers 2110. One example of a software program embodied as the one or more object rendering systems 2170 can include PhotoRealistic RenderMan, or PRMan, produced by Pixar Animations Studios of Emeryville, California.

In various embodiments, the one or more object rendering systems 2170 can be configured to render one or more objects to produce one or more computer-generated images or a set of images over time that provide an animation. The one or more object rendering systems 2170 may generate digital images or raster graphics images.

In various embodiments, a rendered image can be understood in terms of a number of visible features. Some examples of visible features that may be considered by the one or more object rendering systems 2170 may include shading (e.g., techniques relating to how the color and brightness of a surface varies with lighting), texture-mapping (e.g., techniques relating to applying detail information to surfaces or objects using maps), bump-mapping (e.g., techniques relating to simulating small-scale bumpiness on surfaces), fogging/participating medium (e.g., techniques relating to how light dims when passing through non-clear atmosphere or air) shadows (e.g., techniques relating to effects of obstructing light), soft shadows (e.g., techniques relating to varying darkness caused by partially obscured light sources), reflection (e.g., techniques relating to mirror-like or highly glossy reflection), transparency or opacity (e.g., techniques relating to sharp transmissions of light through solid objects), translucency (e.g., techniques relating to highly scattered transmissions of light through solid objects), refraction (e.g., techniques relating to bending of light associated with transparency), diffraction (e.g., techniques relating to bending, spreading and interference of light passing by an object or aperture that disrupts the ray), indirect illumination (e.g., techniques relating to surfaces illuminated by light reflected off other surfaces, rather than directly from a light source, also known as global illumination), caustics (e.g., a form of indirect illumination with techniques relating to reflections of light off a shiny object, or focusing of light through a transparent object, to produce bright highlights on another object), depth of field (e.g., techniques relating to how objects appear blurry or out of focus when too far in front of or behind the object in focus), motion blur (e.g., techniques relating to how objects appear blurry due to high-speed motion, or the motion of the camera), non-photorealistic rendering (e.g., techniques relating to rendering of scenes in an artistic style, intended to look like a painting or drawing), or the like.

The one or more object rendering systems 2170 may further render images (e.g., motion and position of an object over time) for use by other elements of system 2100 or that can be stored in object library 2120. The one or more object rendering systems 2170 may be configured to allow a user to associate additional information or metadata with all or a portion of the rendered image.

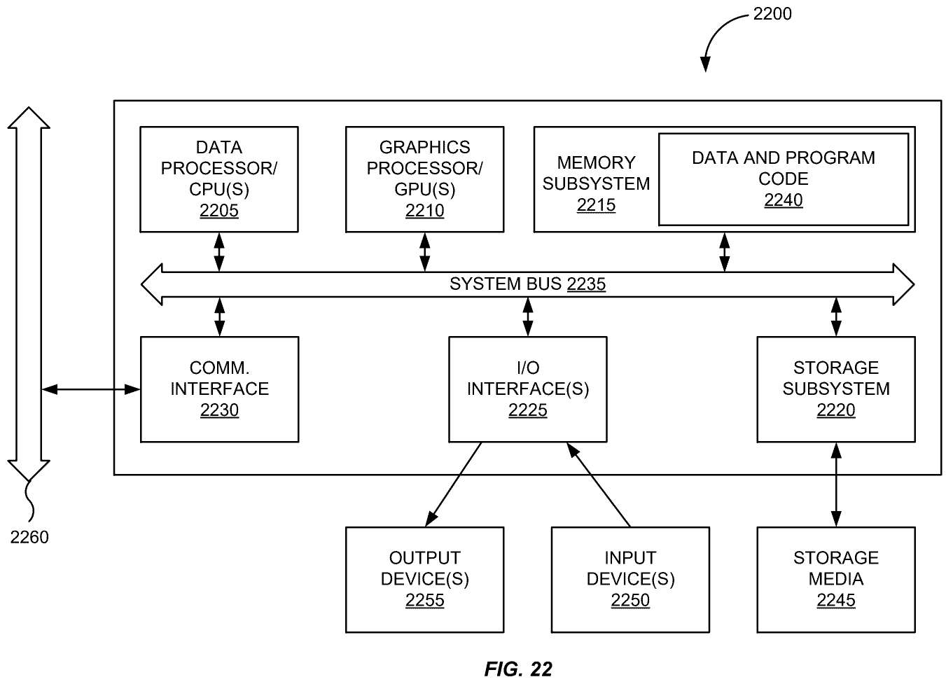

FIG. 22 is a block diagram of computer system 2200. FIG. 22 is merely illustrative. In some embodiments, a computer system includes a single computer apparatus, where the subsystems can be the components of the computer apparatus. In other embodiments, a computer system can include multiple computer apparatuses, each being a subsystem, with internal components. Computer system 2200 and any of its components or subsystems can include hardware and/or software elements configured for performing methods described herein.

Computer system 2200 may include familiar computer components, such as one or more one or more data processors or central processing units (CPUs) 2205, one or more graphics processors or graphical processing units (GPUs) 2210, memory subsystem 2215, storage subsystem 2220, one or more input/output (I/O) interfaces 2225, communications interface 2230, or the like. Computer system 2200 can include system bus 2235 interconnecting the above components and providing functionality, such connectivity and inter-device communication.

The one or more data processors or central processing units (CPUs) 2205 can execute logic or program code or for providing application-specific functionality. Some examples of CPU(s) 2205 can include one or more microprocessors (e.g., single core and multi-core) or micro-controllers, one or more field-gate programmable arrays (FPGAs), and application-specific integrated circuits (ASICs). As user herein, a processor includes a multi-core processor on a same integrated chip, or multiple processing units on a single circuit board or networked.

The one or more graphics processor or graphical processing units (GPUs) 2210 can execute logic or program code associated with graphics or for providing graphics-specific functionality. GPUs 2210 may include any conventional graphics processing unit, such as those provided by conventional video cards. In various embodiments, GPUs 2210 may include one or more vector or parallel processing units. These GPUs may be user programmable, and include hardware elements for encoding/decoding specific types of data (e.g., video data) or for accelerating 2D or 3D drawing operations, texturing operations, shading operations, or the like. The one or more graphics processors or graphical processing units (GPUs) 2210 may include any number of registers, logic units, arithmetic units, caches, memory interfaces, or the like.

Memory subsystem 2215 can store information, e.g., using machine-readable articles, information storage devices, or computer-readable storage media. Some examples can include random access memories (RAM), read-only-memories (ROMS), volatile memories, non-volatile memories, and other semiconductor memories. Memory subsystem 2215 can include data and program code 2240.

Storage subsystem 2220 can also store information using machine-readable articles, information storage devices, or computer-readable storage media. Storage subsystem 2220 may store information using storage media 2245. Some examples of storage media 2245 used by storage subsystem 2220 can include floppy disks, hard disks, optical storage media such as CD-ROMS, DVDs and bar codes, removable storage devices, networked storage devices, or the like. In some embodiments, all or part of data and program code 2240 may be stored using storage subsystem 2220.

The one or more input/output (I/O) interfaces 2225 can perform I/O operations. One or more input devices 2250 and/or one or more output devices 2255 may be communicatively coupled to the one or more I/O interfaces 2225. The one or more input devices 2250 can receive information from one or more sources for computer system 2200. Some examples of the one or more input devices 2250 may include a computer mouse, a trackball, a track pad, a joystick, a wireless remote, a drawing tablet, a voice command system, an eye tracking system, external storage systems, a monitor appropriately configured as a touch screen, a communications interface appropriately configured as a transceiver, or the like. In various embodiments, the one or more input devices 2250 may allow a user of computer system 2200 to interact with one or more non-graphical or graphical user interfaces to enter a comment, select objects, icons, text, user interface widgets, or other user interface elements that appear on a monitor/display device via a command, a click of a button, or the like.

The one or more output devices 2255 can output information to one or more destinations for computer system 2200. Some examples of the one or more output devices 2255 can include a printer, a fax, a feedback device for a mouse or joystick, external storage systems, a monitor or other display device, a communications interface appropriately configured as a transceiver, or the like. The one or more output devices 2255 may allow a user of computer system 2200 to view objects, icons, text, user interface widgets, or other user interface elements. A display device or monitor may be used with computer system 2200 and can include hardware and/or software elements configured for displaying information.

Communications interface 2230 can perform communications operations, including sending and receiving data. Some examples of communications interface 2230 may include a network communications interface (e.g., Ethernet, Wi-Fi, etc.). For example, communications interface 2230 may be coupled to communications network/external bus 2260, such as a computer network, a USB hub, or the like. A computer system can include a plurality of the same components or subsystems, e.g., connected together by communications interface 2230 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

In various embodiments, methods may involve various numbers of clients and/or servers, including at least 10, 20, 50, 100, 200, 500, 1000, or 10,000 devices. Methods can include various numbers of communication messages between devices, including at least 100, 200, 500, 1,000, 10,000, 50,000, 100,000, 500,000 or one million communication messages. Such communications can involve at least 1 MB, 10 MB, 100 MB, 1 GB, 10 GB, or 100 GB of data.

Computer system 2200 may also include one or more applications (e.g., software components or functions) to be executed by a processor to execute, perform, or otherwise implement techniques disclosed herein. These applications may be embodied as data and program code 2240. Additionally, computer programs, executable computer code, human-readable source code, shader code, rendering engines, or the like, and data, such as image files, models including geometrical descriptions of objects, ordered geometric descriptions of objects, procedural descriptions of models, scene descriptor files, or the like, may be stored in memory subsystem 2215 and/or storage subsystem 2220. Any operations performed with a processor (or applications executed by a processor) may be performed in real-time. The term “real-time” may refer to computing operations or processes that are completed within a certain time constraint. As examples, a time constraint may be 30 seconds, 1 minute, 10 minutes, 30 minutes, 1 hour, 4 hours, 1 day, or 7 days.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary.

All patents, patent applications, publications, and descriptions mentioned here are incorporated by reference in their entirety for all purposes. None is admitted to be prior art.

### IX. PATENT LITERATURE AND REFERENCES

[1] Denoising binned-depth images, U.S. Pat. No. 10,565,685B2
[2] Denoising Monte Carlo renderings using machine learning with importance sampling, U.S. Pat. No. 10,572,979Bs
[3] Denoising Monte Carlo renderings using neural networks with asymmetric loss, US20190304069A1
[4] Multi-scale architecture of denoising Monte Carlo renderings using neural networks, US20190304068A1
[5] Temporal techniques of denoising Monte Carlo renderings using neural networks, US20190304067A1
[6] Kernel-predicting convolutional neural networks for denoising, U.S. Pat. No. 10,475,165B2 and US20200027198A1
[7] Denoising Monte Carlo renderings using progressive neural networks, US20180293496A1
[8] Robust regression methods for image-space denoising, U.S. Pat. No. 10,096,088B2
[9] Attention is all you need: arxiv.org/abs/1706.03762
[10] Rousselle et al. 2013—Robust Denoising using Feature and Color Information. onlinelibrary.wiley.com/doi/abs/10.1111/cgf.12219
[11] Kingma and Ba 2015—Adam: A Method for Stochastic Optimization. arxiv.org/abs/1412.6980
[12] Ronneberger et al. 2015—U-Net: Convolutional Networks for Biomedical Image. arxiv.org/abs/1505.04597
[13] Bako et al. 2017—Kernel-predicting convolutional networks for denoising Monte Carlo renderings. dl.acm.org/doi/10.1145/3072959.3073708
[14] Vogels et al. 2018—Denoising with kernel prediction and asymmetric loss functions. graphics.pixar.com/library/MLDenoising2018/paper.pdf
[15] Vicini et al. 2019—Denoising Deep Monte Carlo Renderings. onlinelibrary.wiley.com/doi/10.1111/cgf.13533
[16] Zhang et al. 2021—Deep Compositional Denoising for High-quality Monte Carlo Rendering. onlinelibrary.wiley.com/doi/10.1111/cgf.14337
[17] Luo and Hu 2021—Score-Based Point Cloud Denoising. arxiv.org/abs/2107.10981
[18] Zhang et al. 2024—Neural Denoising for Deep-Z Monte Carlo Renderings. diglib.cg.org/handle/10.1111/cgf15050

What is claimed is:

1. A method for denoising a deep image comprising a plurality of pixels, each pixel corresponding to one or more bins, the deep image thereby comprising a plurality of bins, the method comprising performing, by a computer system:
generating, using an embedding sub-model, a deep image embedding by:
determining a plurality of local bin sets corresponding to the plurality of bins, each local bin set comprising a plurality of local bins from the plurality of bins and a respective focal bin, each plurality of local bins being within a specified distance of the respective focal bin,
generating, for each focal bin using the embedding sub-model, a bin embedding based on attention of a corresponding local bin set, thereby generating a plurality of bin embeddings,
generating the deep image embedding based on the plurality of bin embeddings; and
generating a denoised deep image by generating a plurality of denoised bins using a denoising sub-model applied to the plurality of bins of the deep image and the deep image embedding, wherein the denoised deep image comprises the plurality of denoised bins.

2. The method of claim 1, further comprising, prior to generating a deep image embedding, initially processing the plurality of bins by processing a plurality of layer values associated with the plurality of bins.

3. The method of claim 2, wherein the plurality of layer values are processed by applying one or more operations of a plurality of operations to each layer value of the plurality of layer values, the plurality of operations comprising:
log transforming the layer value;
clipping the layer value to a predetermined range;
unpremultiplying the layer value;
performing a reciprocal operation on the layer value;
sine encoding the layer value;
converting the layer value to an add-alpha format; and
one-hot encoding the layer value.

4. The method of claim 1, wherein each specified distance comprises a specified radius, and wherein each local bin set corresponds to a respective circular region or a respective conic region defined by a respective specified radius.

5. The method of claim 1, wherein:
the embedding sub-model comprises a multiscale network corresponding to one or more downscaling factors;
the plurality of local bin sets comprise a plurality of full-scale local bin sets;
the plurality of bin embeddings comprise a plurality of full-scale bin embeddings;
generating the deep image embedding using the embedding sub-model comprises:
determining one or more pluralities of initial downscaled local bin embedding sets, each initial downscaled local bin embedding set comprising a plurality of initial downscaled local bin embeddings and a respective initial downscaled focal bin embedding, each plurality of initial downscaled local bin embeddings being within a specified downscaled distance of the respective initial downscaled focal bin embedding, wherein the one or more pluralities of initial downscaled local bin embedding sets correspond to the one or more downscaling factors,
generating, for each initial downscaled focal bin embedding using the embedding sub-model, one or more downscaled bin embeddings based on attention of a corresponding initial downscaled local bin embedding set, thereby generating one or more pluralities of downscaled bin embeddings, wherein the one or more pluralities of downscaled bin embeddings correspond to the one or more downscaling factors; and
the deep image embedding is generated based on the one or more pluralities of downscaled bin embeddings in addition to the plurality of bin embeddings.

6. The method of claim 5, wherein:
the one or more downscaling factors comprise a quarter-scale factor and a sixteenth-scale factor;
the one or more pluralities of initial downscaled local bin embedding sets comprise a plurality of quarter-scale local bin embedding sets and a plurality of sixteenth-scale local bin embedding sets; and
the one or more pluralities of downscaled bin embeddings comprise a plurality of quarter-scale local bin embeddings and a plurality of sixteenth-scale local bin embeddings.

7. The method of claim 5, wherein generating the deep image embedding further comprises:
generating each full-scale bin embedding of the plurality of full-scale bin embeddings using a local attention transformer based on attention of a corresponding full-scale local bin set, thereby generating the plurality of full-scale bin embeddings; and
performing one or more downscaling operations on the plurality of full-scale bin embeddings, thereby generating one or more pluralities of initial downscaled bin embeddings, wherein each plurality of initial downscaled local bin embedding sets are determined from a corresponding plurality of initial downscaled bin embeddings.

8. The method of claim 7, wherein downscaling the plurality of full-scale bin embeddings comprises performing random or regular pattern per-pixel bin dropout, or random or regular pattern bin dropout, thereby removing one or more bin embeddings from the plurality of full-scale bin embeddings, wherein a number of removed bin embeddings is proportional to the one or more downscaling factors.

9. The method of claim 5, wherein the embedding sub-model comprises one or more additional multiscale networks, wherein the multiscale network and the one or more additional multiscale networks are arranged in a sequence of multiscale networks, such that an output of each multiscale network or additional multiscale network comprises an input to a subsequent additional multiscale network or comprises an output of the sequence of multiscale networks, and wherein generating the deep image embedding based on the one or more pluralities of downscaled bin embeddings and the plurality of bin embeddings comprises:
combining, using a sub-network of the multiscale network, the one or more pluralities of downscaled bin embeddings and the plurality of bin embeddings, thereby generating an intermediate deep image embedding; and
applying the intermediate deep image embedding to the one or more additional multiscale networks in the sequence of multiscale networks, thereby generating the deep image embedding.

10. The method of claim 9, wherein the sequence of multiscale networks additionally comprises one or more mixing transformers, and wherein the method further comprises:
temporally denoising the deep image using the one or more mixing transformers, wherein the deep image and a plurality of additional deep images comprise a sequence of deep image frames corresponding to a video, wherein the deep image comprises a center frame of the sequence of deep image frames.

11. The method of claim 1, wherein generating the denoised deep image comprises:
determining one or more pluralities of local bin embedding sets corresponding to the deep image embedding, each local bin embedding set comprising a plurality of local bin embeddings derived from the deep image embedding and a respective focal bin embedding, each plurality of local bin embeddings being within a specified distance of the respective focal bin embedding;
generating, using the denoising sub-model, one or more intermediate denoised deep images based on cross-attention between each bin of the deep image and one or more corresponding local bin embedding sets corresponding to each bin, wherein each intermediate denoised deep image comprises a plurality of intermediate denoised bins; and
generating the denoised deep image based on the one or more intermediate denoised deep images.

12. The method of claim 11, wherein generating the denoised deep image comprises combining the one or more intermediate denoised deep images using a linear blending layer.

13. The method of claim 11, wherein each bin of the plurality of bins corresponds to one or more layer values that correspond to one or more layers, wherein the denoising sub-model comprises one or more layer blocks corresponding to the one or more layers, and wherein generating the one or more intermediate denoised deep images are performed on a per-layer basis using the one or more layer blocks, such that each intermediate denoised deep image comprises one or more intermediate denoised deep image layers corresponding to the one or more layers.

14. The method of claim 11, wherein:
the denoising sub-model comprises a multiscale network corresponding to the one or more downscaling factors;
the one or more pluralities of local bin embedding sets comprise a plurality of full-scale local bin embedding sets and one or more pluralities of downscaled local bin embedding sets corresponding to the one or more downscaling factors; and
the one or more intermediate denoised deep images comprise a full-scale intermediate denoised deep image and one or more downscaled intermediate denoised deep images corresponding to the one or more downscaling factors.

15. The method of claim 14, wherein:
generating the denoised deep image further comprises downscaling the deep image embedding based on the one or more downscaling factors, thereby generating one or more downscaled deep image embeddings; and
determining the one or more pluralities of local bin embedding sets comprises:
determining the plurality of full-scale local bin embedding sets based on the deep image embedding, and
determining the one or more pluralities of downscaled local bin embedding sets based on the one or more downscaled deep image embeddings.

16. The method of claim 15, wherein generating the one or more intermediate denoised deep images comprises:
generating, using a full-scale denoising attention element, the full-scale intermediate denoised deep image based on cross-attention between each bin of the plurality of bins and a corresponding full-scale local bin embedding set of the plurality of full-scale local bin embedding sets, wherein the full-scale intermediate denoised deep image comprises a plurality of full-scale intermediate denoised bins;
generating, for each downscaled deep image embedding of the one or more downscaled deep image embeddings, using one or more blurring attention elements corresponding to the one or more downscaling factors, a blurred deep image based on cross-attention between each bin of the plurality of bins and one or more corresponding downscaled local bin embedding sets, thereby generating one or more blurred deep images, each blurred deep image comprising a plurality of blurred bins;
determining, for each blurred deep image of the one or more blurred deep images, a plurality of blurred local bin sets, each blurred local bin set comprising a plurality of blurred local bins from a corresponding blurred deep image, each plurality of blurred local bins being within a specified distance of a respective blurred focal bin, thereby determining one or more pluralities of blurred local bin sets; and
generating, for each plurality of blurred local bin sets of the one or more pluralities of blurred local bin sets, using one or more denoising attention elements corresponding to the one or more downscaling factors, an intermediate downscaled denoised deep image based on cross-attention between each blurred local bin set, a corresponding downscaled local bin embedding set, and a corresponding full-scale local bin embedding set, thereby generating one or more intermediate downscaled denoised deep images, wherein each intermediate downscaled denoised deep image comprises a plurality of downscaled denoised bins.

17. The method of claim 16, wherein:
each full-scale local bin embedding set corresponds to a circular full-scale local region defined by a specified radius value;
each downscaled local bin embedding set corresponds to a circular downscaled local region defined by a specified downscaled radius value; and
each blurred local bin set corresponds to a circular downscaled denoising local region defined by a specified downscaled denoising radius value.

18. A method for training a machine learning model to denoise deep images comprising pluralities of pixels, each pixel corresponding to one or more bins, each deep image thereby comprising a plurality of bins, wherein the machine learning model comprises an embedding sub-model and a denoising sub-model, and wherein the method is performed by a computer system and comprises performing an iterative training process until a terminating condition has been met, the method comprising:
sampling a batch of training deep images comprising one or more training deep images, each training deep image comprising a plurality of training bins;
generating, using the embedding sub-model, one or more training deep image embeddings by performing, for each training deep image of the one or more training deep images:
determining a plurality of local bin sets corresponding to the plurality of training bins, each local bin set comprising a plurality of local bins from the plurality of training bins and a respective focal training bin, each plurality of local bins being within a specified distance of the respective focal training bin,
generating, for each focal training bin using the embedding sub-model, a training bin embedding based on attention of a corresponding local bin set, thereby generating a plurality of training bin embeddings, and
generating a training deep image embedding based on the plurality of training bin embeddings, thereby generating the one or more training deep image embeddings;
generating one or more denoised training deep images by generating, for each training deep image, a denoised training deep image by generating a plurality of denoised training bins using the denoising sub-model applied to the plurality of training bins of a corresponding training deep image and a corresponding training deep image embedding, thereby generating the one or more denoised training deep images;
determining one or more loss values based on the one or more denoised training deep images;
updating a parameter set of the machine learning model based on the one or more loss values, thereby training the machine learning model; and
if the terminating condition has not been met, repeating the iterative training process until the terminating condition has been met, otherwise completing the iterative training process.

19. The method of claim 18, wherein the one or more training deep images correspond to one or more reference deep images, and wherein the one or more loss values are determined by comparing the one or more denoised training deep images to the one or more reference deep images.

20. A computer system comprising:
one or more processors; and
a non-transitory computer readable medium coupled to the one or more processors, the non-transitory computer readable medium comprising code executable by the one or more processors for performing a method for denoising a deep image comprising a plurality of pixels, each pixel corresponding to one or more bins, the deep image thereby comprising a plurality of bins, the method comprising:
generating, using an embedding sub-model, a deep image embedding by:
determining a plurality of local bin sets corresponding to the plurality of bins, each local bin set comprising a plurality of local bins from the plurality of bins and a respective focal bin, each plurality of local bins being within a specified distance of the respective focal bin,
generating, for each focal bin using the embedding sub-model, a bin embedding based on attention of a corresponding local bin set, thereby generating a plurality of bin embeddings,
generating the deep image embedding based on the plurality of bin embeddings; and
generating a denoised deep image by generating a plurality of denoised bins using a denoising sub-model applied to the plurality of bins of the deep image and the deep image embedding, wherein the denoised deep image comprises the plurality of denoised bins.
